(19) United States
(12) Patent Application Publication
(10) Pub. No.: US 2017/0192392 A1
(43) Pub. Date: Jul. 6, 2017

(54) ORNAMENT

(71) Applicant: Seiko Epson Corporation, Tokyo (JP)

(72) Inventor: Hidefumi NAKAMURA, Hachinohe (JP)

(21) Appl. No.: 15/398,039

(22) Filed: Jan. 4, 2017

(30) Foreign Application Priority Data
Jan. 6, 2016 (JP) 2016-000890

(51) Int. Cl. G04B 45/00; C22C 38/48; B22F 5/10; C22C 38/04; C22C 38/02; C22C 38/00; C22C 38/50; C22C 38/44

(52) U.S. Cl. CPC G04B 45/00; C22C 38/50; C22C 38/48; C22C 38/44; C22C 38/04; C22C 38/02; C22C 38/002; B22F 5/106; B22F 2301/35

(57) ABSTRACT

An ornament includes a sintered body, in which Fe, Cr, Ni, Si, and C are contained, and when one element selected from the group consisting of Ti, V, Y, Zr, Nb, Hf, and Ta is defined as a first element, and one element selected from the group, and having a higher group number in the periodic table than that of the first element or having the same group number as that of the first element and a higher period number than that of the first element is defined as a second element, the first element is contained in a proportion of 0.01 mass % or more and 0.5 mass % or less, and the second element is contained in a proportion of 0.01 mass % or more and 0.5 mass % or less.

### CROSS-REFERENCE TO RELATED APPLICATION

This application claims priority to Japanese Patent Application No. 2016-000890 filed on Jan. 6, 2016. The entire disclosure of Japanese Patent Application No. 2016-000890 is hereby incorporated herein by reference.

### BACKGROUND

1. Technical Field

The present invention relates to an ornament.

2. Related Art

For ornaments such as exterior components for timepieces, first of all, excellent aesthetic appearance is required. One of the factors of this aesthetic appearance is a texture characteristic of a metal material, and maintenance of a state of the ornament at the time of production over a long period of time without causing deterioration or the like of the metal material results in maintenance of this texture.

As one of the methods for producing an ornament, a powder metallurgy method has been known. According to a powder metallurgy method, by molding a metal powder using a mold, an ornament composed of a metal structure having a desired shape can be efficiently produced.

For example, JP-A-2012-87416 (Patent Document 1) has proposed a metal powder for powder metallurgy containing Zr and Si, with the remainder consisting of at least one element selected from the group consisting of Fe, Co, and Ni, and unavoidable elements. By applying such a metal powder for powder metallurgy to a powder metallurgy method, the sinterability is improved by the action of Zr, and a sintered body having a desired shape and also having a high density can be easily produced.

On the other hand, for an ornament, by subjecting the surface to a polishing operation in the process of production, excellent aesthetic appearance is obtained. Further, in order to remove a shallow scratch resulting from normal use, a polishing operation is sometimes performed again for an ornament after production. In such a polishing operation, by lightly polishing the surface of the ornament, the surface layer including the scratch is removed.

However, a sintered body produced by a powder metallurgy method includes pores, and therefore, the pores are exposed by polishing. As a result, the texture characteristic of a metal material is deteriorated, and a problem arises that the aesthetic appearance of the ornament is deteriorated.

### SUMMARY

An advantage of some aspects of the invention is to provide an ornament which exhibits favorable aesthetic appearance even if it is polished.

The advantage can be achieved by the following configurations.

An ornament according to an aspect of the invention includes a sintered body, wherein in the sintered body, Fe is contained as a major component, Cr is contained in a proportion of 15 mass % or more and 26 mass % or less, Ni is contained in a proportion of 7 mass % or more and 22 mass % or less, Si is contained in a proportion of 0.3 mass % or more and 1.2 mass % or less, C is contained in a proportion of 0.005 mass % or more and 0.3 mass % or less, and when one element selected from the group consisting of Ti, V, Y, Zr, Nb, Hf, and Ta is defined as a first element, and one element selected from the group consisting of Ti, V, Y, Zr, Nb, Hf, and Ta, and having a higher group number in the periodic table than that of the first element or having the same group number in the periodic table as that of the first element and a higher period number in the periodic table than that of the first element is defined as a second element, the first element is contained in a proportion of 0.01 mass % or more and 0.5 mass % or less, and the second element is contained in a proportion of 0.01 mass % or more and 0.5 mass % or less, and in a cross section of a surface layer with a thickness of 200 μm from the surface, when the area ratio of a first region D1 in which Fe is contained as a major component is represented by P1 and the area ratio of a second region D2 in which Si or O is contained as a major component is represented by P2, P2/(P1+P2) is 0.3% or less.

According to this, the formation of pores is suppressed as the density of the sintered body is increased, and therefore, an ornament capable of maintaining favorable aesthetic appearance even if it is polished is obtained.

In the ornament according to the aspect of the invention, it is preferred that the relative density of the sintered body is 98% or more.

According to this, an ornament, which has excellent mechanical properties comparable to those of an ingot material, and also in which the formation of pores in a surface layer is suppressed is obtained.

In the ornament according to the aspect of the invention, it is preferred that the sintered body has an austenite crystal structure.

According to this, high corrosion resistance and large elongation are imparted to the sintered body, and therefore, an ornament having high corrosion resistance and also excellent impact resistance is obtained.

In the ornament according to the aspect of the invention, it is preferred that the ornament is an external component for timepieces.

According to this, an external component for timepieces, which exhibits favorable aesthetic appearance even if it is polished, is obtained.

### BRIEF DESCRIPTION OF THE DRAWINGS

The invention will be described with reference to the accompanying drawings, wherein like numbers reference like elements.

FIG. 1 is a perspective view showing a watch case to which an embodiment of an ornament according to the invention is applied.

FIG. 2 is a partial cross-sectional perspective view showing a bezel to which an embodiment of an ornament according to the invention is applied.

FIG. 3 is a perspective view showing a ring to which an embodiment of an ornament according to the invention is applied.

FIG. 4 is a plan view showing a knife to which an embodiment of an ornament according to the invention is applied.

FIG. 5 is a schematic view showing a cross section of a surface layer of a sintered body to be used in an embodiment of an ornament according to the invention.

### DESCRIPTION OF EXEMPLARY EMBODIMENTS

Hereinafter, an ornament according to the invention will be described in detail.

### Ornament

An ornament according to the invention is an article including parts constituted by the below-mentioned sintered body of a metal powder.

An embodiment of the ornament according to the invention can be applied to, for example, external components for timepieces such as watch cases (case bodies, case backs, one-piece cases in which a case body and a case back are integrated, etc.), watch bands (including band clasps, band-bangle attachment mechanisms, etc.), bezels (for example, rotatable bezels, etc.), crowns (for example, screw-lock crowns, etc.), buttons, glass frames, dial rings, etching plates, and packings, personal ornaments such as glasses (for example, glasses frames), tie clips, cuff buttons, rings, necklaces, bracelets, anklets, brooches, pendants, earrings, and pierced earrings, utensils such as spoons, forks, chopsticks, knives, butter knives, and corkscrews, lighters or lighter cases, sports goods such as golf clubs, various types of apparatus components such as nameplates, panels, prize cups, and other housings (for example, housings for cellular phones, smartphones, tablet terminals, mobile computers, music players, cameras, shavers, etc.), various types of containers, and the like.

For any of these articles, excellent aesthetic appearance is required, and therefore, the surface is smoothened by polishing or the like. By doing this, the ornament exhibits a texture characteristic of a metal material, and acquires excellent aesthetic appearance. As a result, the ornament can enhance its value.

Further, any of these articles is an article which can be used in contact with the human skin, and therefore is also required to have resistance to body fluids such as sweat and saliva, food, detergents, other chemicals, and the like. Therefore, by applying the ornament according to the invention to these articles, an ornament having excellent corrosion resistance, that is, an ornament capable of maintaining excellent aesthetic appearance over a long period of time, and also is hardly deteriorated or the like by body fluids and the like can be realized.

Hereinafter, an embodiment of the ornament according to the invention will be described by showing an external component for timepieces, a personal ornament, and a utensil as examples.

### External Component for Timepieces

First, an external component for timepieces to which an embodiment of an ornament according to the invention is applied will be described.

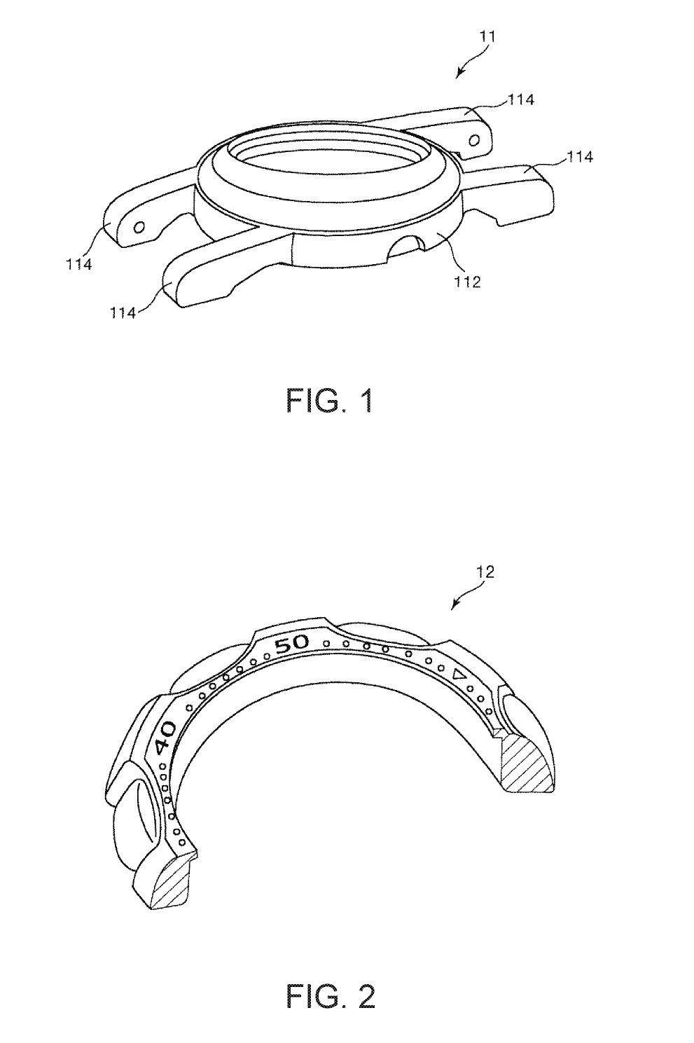

FIG. 1 is a perspective view showing a watch case to which an embodiment of the ornament according to the invention is applied, and FIG. 2 is a partial cross-sectional perspective view showing a bezel to which an embodiment of the ornament according to the invention is applied.

A watch case 11 shown in FIG. 1 includes a case main body 112 and a band attachment section 114 for attaching a watch band provided protruding from the case main body 112. Such a watch case 11 can construct a container along with a glass plate (not shown) and a case back (not shown). In this container, a movement (not shown), a dial plate (not shown), etc. are housed. Therefore, this container protects the movement and the like from the external environment and also has a large influence on the aesthetic appearance of the watch.

A bezel 12 shown in FIG. 2 has an annular shape, and is attached to a watch case, and is rotatable with respect to the watch case as needed. When the bezel 12 is attached to a watch case, the bezel 12 is located outside the watch case, and therefore has an influence on the aesthetic appearance of the watch.

On the other hand, external components for timepieces such as a watch case 11 and a bezel 12 easily get scratched when wearing a watch. Therefore, by subjecting the surfaces of the watch case 11 and the bezel 12 to a polishing operation, maintenance for making a scratch shallower or removing a scratch is performed. At this time, by including the below-mentioned sintered body in the watch case 11 and the bezel 12, pores are hardly exposed on the polished surfaces, and the polished surfaces are smoothened. According to this, a texture characteristic of a metal material can be imparted to the surfaces of the watch case 11 and the bezel 12, and therefore, excellent aesthetic appearance can be ensured.

Further, such a watch case 11 and a bezel 12 are used in a state of being in contact with the human wrist or the like, and therefore come in contact with sweat over a long period of time. Due to this, in the case where the corrosion resistance of the watch case 11 and the bezel 12 is low, rust is caused by sweat, and deterioration of the aesthetic appearance, a decrease in the mechanical properties, or the like may be caused. Therefore, by using the below-mentioned skin contact material as a constituent material of such an external component for timepieces, an external component for timepieces having excellent corrosion resistance is obtained.

### Personal Ornament

Next, a personal ornament to which an embodiment of the ornament according to the invention is applied will be described.

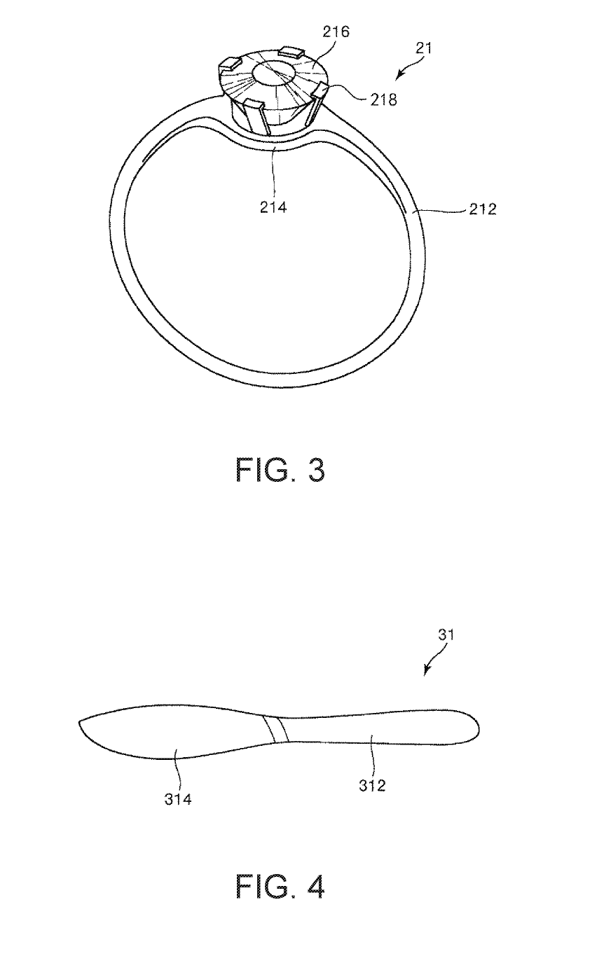

FIG. 3 is a perspective view showing a ring to which an embodiment of the ornament according to the invention is applied.

A ring 21 shown in FIG. 3 includes a ring main body 212, a bezel 214 provided for the ring main body 212, and a cut gem 216 attached to the bezel 214. In this ring 21, the ring main body 212 and the bezel 214 are integrally formed from the below-mentioned skin contact material. Further, the cut gem 216 is fixed by claws 218 included in the bezel 214.

On the other hand, the ring main body 212 and the bezel 214 easily get scratched when wearing the ring 21. Therefore, by subjecting the surfaces of the ring main body 212 and the bezel 214 to a polishing operation, maintenance for making a scratch shallower or removing a scratch is performed. At this time, by including the below-mentioned sintered body in the ring main body 212 and the bezel 214, pores are hardly exposed on the polished surfaces, and the polished surfaces are smoothened. According to this, a texture characteristic of a metal material can be imparted to the surfaces of the ring main body 212 and the bezel 214, and therefore, excellent aesthetic appearance can be ensured.

Further, the ring main body 212 and the bezel 214 are used in a state of being in contact with the human finger or the like, and therefore also come in contact with sweat over a long period of time. Due to this, in the case where the corrosion resistance of the ring main body 212 and the bezel 214 is low, rust is caused by sweat, and deterioration of the aesthetic appearance or a decrease in the mechanical properties may be caused. Therefore, by using the below-mentioned skin contact material as a constituent material of the ring main body 212 and the bezel 214, a personal ornament having excellent corrosion resistance is obtained.

### Utensil

Next, a utensil to which an embodiment of the ornament according to the invention is applied will be described.

FIG. 4 is a plan view showing a knife to which an embodiment of the ornament according to the invention is applied.

A knife 31 shown in FIG. 4 includes a handle section 312 and a blade section 314 extending from the handle section 312. The handle section 312 and the blade section 314 are integrally formed from the below-mentioned skin contact material (a material for an ornament). Further, the handle section 312 is used in a state of being in contact with the human hand or the like, and therefore also comes in contact with sweat over a long period of time. Further, the blade section 314 is used in a state of being in contact with food or the like, and therefore comes in contact with an acid or the like. Due to this, in the case where the corrosion resistance of the handle section 312 and the blade section 314 is low, rust is caused by sweat or an acid, and deterioration of the aesthetic appearance or a decrease in the mechanical properties may be caused. Therefore, by using the below-mentioned skin contact material as a constituent material of the handle section 312 and the blade section 314, a utensil having excellent corrosion resistance is obtained.

On the other hand, the handle section 312 and the blade section 314 easily get scratched when using the knife 31. Therefore, by subjecting the surfaces of the handle section 312 and the blade section 314 to a polishing operation, maintenance for making a scratch shallower or removing a scratch is performed. At this time, by including the below-mentioned sintered body in the handle section 312 and the blade section 314, pores are hardly exposed on the polished surfaces, and the polished surfaces are smoothened. According to this, a texture characteristic of a metal material can be imparted to the surfaces of the handle section 312 and the blade section 314, and therefore, excellent aesthetic appearance can be ensured.

The shapes of the external component for timepieces, the personal ornament, and the utensil as described above are merely examples, and the embodiment of the ornament according to the invention is not limited to the shapes shown in the drawings. For example, the external component for timepieces is not limited to the external component for watches, and can also be applied to an external component for pocket watches.

### Constituent Material of Ornament

Next, materials constituting the ornament according to the invention will be described. The ornament according to the invention includes apart constituted by a sintered body produced by a powder metallurgy method. Hereinafter, the sintered body will be described.

In powder metallurgy, a composition containing a metal powder for powder metallurgy and a binder is molded into a desired shape, and the obtained molded body is degreased and sintered, whereby a sintered body having a desired shape is obtained. According to such a powder metallurgy technique, an advantage that a sintered body with a complicated and fine shape can be produced in a near-net shape (a shape close to a final shape) is obtained as compared with the other metallurgy techniques.

A metal powder for powder metallurgy to be used for producing the ornament according to the invention is a metal powder which contains Cr in a proportion of 15 mass % or more and 26 mass % or less, Ni in a proportion of 7 mass % or more and 22 mass % or less, Si in a proportion of 0.3 mass % or more and 1.2 mass % or less, C in a proportion of 0.005 mass % or more and 0.3 mass % or less, the below-mentioned first element in a proportion of 0.01 mass % or more and 0.5 mass % or less, the below-mentioned second element in a proportion of 0.01 mass % or more and 0.5 mass % or less, with the remainder consisting of Fe and other elements. According to such a metal powder, as a result of optimizing the alloy composition, the densification during sintering can be particularly enhanced. As a result, a sintered body having a high density can be produced without performing an additional treatment.

A region with a thickness of 200 μm from the surface of this sintered body as a starting point is defined as “surface layer”. In the cross section of this surface layer, a region in which Fe is contained as a major component is defined as a first region D1, and a region in which Si or O is contained as a major component is defined as a second region D2. Further, the area ratio of the first region D1 in the cross section of this surface layer is represented by P1, and the area ratio of the second region D2 in the cross section of this surface layer is represented by P2.

At this time, the sintered body satisfies the condition that P2/(P1+P2) is 0.3% or less.

In such a sintered body, particularly, the content of pores in the surface layer is decreased. Therefore, even if the surface is polished, the number or size of pores to be exposed is suppressed, and thus, the adverse effect of the pores on the aesthetic appearance can be minimized. As a result, a sintered body whose polished surface has excellent aesthetic appearance is obtained. Such a sintered body contributes to the improvement of the aesthetic appearance of an ornament.

Further, by increasing the density of such a sintered body, the sintered body has excellent mechanical properties. Due to this, the abrasion resistance and durability of the ornament can be further increased.

The first element is one element selected from the group consisting of the following seven elements: Ti, V, Y, Zr, Nb, Hf, and Ta, and the second element is one element selected from the group consisting of the above-mentioned seven elements and having a higher group number in the periodic table than that of the first element or one element selected from the group consisting of the above-mentioned seven elements and having the same group number in the periodic table as that of the element selected as the first element and a higher period number in the periodic table than that of the first element.

Hereinafter, the alloy composition of the sintered body to be used in the invention will be described in further detail.

Cr (chromium) is an element which imparts corrosion resistance to a sintered body to be produced. By including Cr, a sintered body capable of maintaining high mechanical properties over a long period of time is obtained.

The content of Cr in the sintered body is set to 15 mass % or more and 26 mass % or less, but is set to preferably 15.5 mass % or more and 25 mass % or less, more preferably 16 mass % or more and 21 mass % or less, further more preferably 16 mass % or more and 20 mass % or less. When the content of Cr is less than the above lower limit, the corrosion resistance of a sintered body to be produced is insufficient depending on the overall composition. On the other hand, when the content of Cr exceeds the above upper limit, the sinterability is deteriorated depending on the overall composition, and therefore, it becomes difficult to increase the density of the sintered body.

A more preferred range of the content of Cr is defined according to the contents of the below-mentioned Ni and Mo. For example, in the case where the content of Ni is 7 mass % or more and 22 mass % or less and the content of Mo is less than 1.2 mass %, the content of Cr is more preferably 18 mass % or more and 20 mass % or less. On the other hand, in the case where the content of Ni is 10 mass % or more and 22 mass % or less and the content of Mo is 1.2 mass % or more and 5 mass % or less, the content of Cr is more preferably 16 mass % or more and less than 18 mass %.

Ni (nickel) is an element which imparts corrosion resistance and heat resistance to a sintered body to be produced.

The content of Ni in the sintered body is set to 7 mass % or more and 22 mass % or less, but is set to preferably 7.5 mass % or more and 17 mass % or less, more preferably 8 mass % or more and 15 mass % or less. By setting the content of Ni within the above range, a sintered body having excellent mechanical properties over a long period of time is obtained.

When the content of Ni is less than the above lower limit, the corrosion resistance and heat resistance of a sintered body to be produced may not be sufficiently enhanced depending on the overall composition. On the other hand, when the content of Ni exceeds the above upper limit, the corrosion resistance and heat resistance may be deteriorated instead.

Si (silicon) is an element which imparts corrosion resistance and high mechanical properties to a sintered body to be produced, and by including Si, a sintered body capable of maintaining high mechanical properties over a long period of time is obtained.

The content of Si in the sintered body is set to 0.3 mass % or more and 1.2 mass % or less, but is set to preferably 0.4 mass % or more and 1.1 mass % or less, more preferably 0.5 mass % or more and 0.9 mass % or less. When the content of Si is less than the above lower limit, the effect of the addition of Si is weakened depending on the overall composition, and therefore, the corrosion resistance and mechanical properties of a sintered body to be produced are deteriorated. On the other hand, when the content of Si exceeds the above upper limit, the amount of Si is too large depending on the overall composition, and therefore, the corrosion resistance and mechanical properties are deteriorated instead.

C (carbon) can particularly enhance the sinterability and increase the density when it is used in combination with the below-mentioned first element and second element. Specifically, the first element and the second element each form a carbide by binding to C. By dispersedly depositing this carbide, an effect of preventing significant growth of crystal grains is exhibited. A clear reason for obtaining such an effect has not been known, but one of the reasons therefor is considered to be because the dispersed deposit serves as an obstacle to inhibit significant growth of crystal grains, and therefore, a variation in the size of crystal grains is suppressed. Accordingly, it becomes difficult to generate pores in a sintered body, and also the increase in the size of crystal grains is prevented, and thus, a sintered body having a high density and also high mechanical properties is obtained.

The content of C in the sintered body is set to 0.005 mass % or more and 0.3 mass % or less, but is set to preferably 0.008 mass % or more and 0.15 mass % or less, more preferably 0.01 mass % or more and 0.08 mass % or less. When the content of C is less than the above lower limit, crystal grains are liable to grow depending on the overall composition, and therefore, the mechanical properties of the sintered body are insufficient. On the other hand, when the content of C exceeds the above upper limit, the amount of C is too large depending on the overall composition, and therefore, the sinterability is deteriorated instead.

The first element and the second element each deposit a carbide or an oxide (hereinafter also collectively referred to as “carbide or the like”) . It is considered that this deposited carbide or the like inhibits significant growth of crystal grains when the metal powder is sintered. As a result, as described above, it becomes difficult to generate pores in a sintered body, and also the increase in the size of crystal grains is prevented, and thus, a sintered body having a high density and also high mechanical properties is obtained.

In addition, although a detailed description will be given later, the deposited carbide or the like promotes the accumulation of silicon oxide at a crystal grain boundary, and as a result, the sintering is promoted and the density is increased while preventing the increase in the size of crystal grains.

The first element and the second element are two elements selected from the group consisting of Ti, V, Y, Zr, Nb, Hf, and Ta, but preferably include an element belonging to group 3A or group 4A in the long periodic table (Ti, Y, Zr, or Hf) . By including an element belonging to group 3A or group 4A as at least one of the first element and the second element, oxygen contained as an oxide in the metal powder is removed and the sinterability of the metal powder can be particularly enhanced.

The first element may be one element selected from the group consisting of Ti, V, Y, Zr, Nb, Hf, and Ta as described above, but is preferably an element belonging to group 3A or group 4A in the long periodic table in the group consisting of the above-mentioned elements. An element belonging to group 3A or group 4A in the group consisting of the above-mentioned elements removes oxygen contained as an oxide in the metal powder and therefore can particularly enhance the sinterability of the metal powder. According to this, the concentration of oxygen remaining in the crystal grains after sintering can be decreased. As a result, the content of oxygen in the sintered body can be decreased, and the density can be increased. Further, these elements are elements having high activity, and therefore are considered to cause rapid atomic diffusion. Accordingly, this atomic diffusion acts as a driving force, and thereby a distance between particles of the metal powder is efficiently decreased and a neck is formed between the particles, so that the densification of a molded body is promoted. As a result, the density of the sintered body can be further increased.

On the other hand, the second element may be one element selected from the group consisting of Ti, V, Y, Zr, Nb, Hf, and Ta and different from the first element as described above, but is preferably an element belonging to group 5A in the long periodic table in the group consisting of the above-mentioned elements. An element belonging to group 5A in the group consisting of the above-mentioned elements particularly efficiently deposits the above-mentioned carbide or the like, and therefore, can efficiently inhibit significant growth of crystal grains during sintering. As a result, the formation of fine crystal grains is promoted, and thus, the density of the sintered body can be increased and also the mechanical properties of the sintered body can be enhanced.

Incidentally, by the combination of the first element with the second element composed of the elements as described above, the effects of the respective elements are exhibited without inhibiting each other. Due to this, the metal powder containing such a first element and a second element can produce a sintered body having a particularly high density.

More preferably, a combination of the first element which is an element belonging to group 4A with the second element which is Nb is adopted.

Further, still more preferably, a combination of the first element which is Zr or Hf with the second element which is Nb is adopted.

By adopting such a combination, the above-mentioned effect becomes more prominent.

Among these elements, Zr is a ferrite-forming element, and therefore deposits a body-centered cubic lattice phase. This body-centered cubic lattice phase has more excellent sinterability than the other crystal lattice phases, and therefore contributes to the increase in the density of a sintered body.

The content of the first element in the sintered body is set to 0.01 mass % or more and 0.5 mass % or less, but is set to preferably 0.03 mass % or more and 0.2 mass % or less, more preferably 0.05 mass % or more and 0.1 mass % or less. When the content of the first element is less than the above lower limit, the effect of the addition of the first element is weakened depending on the overall composition, and therefore, the density of a sintered body to be produced is not sufficiently increased. On the other hand, when the content of the first element exceeds the above upper limit, the amount of the first element is too large depending on the overall composition and the ratio of the above-mentioned carbide or the like is too high, and therefore, the densification is deteriorated instead.

The content of the second element in the sintered body is set to 0.01 mass % or more and 0.5 mass % or less, but is set to preferably 0.03 mass % or more and 0.2 mass % or less, more preferably 0.05 mass % or more and 0.1 mass % or less. When the content of the second element is less than the above lower limit, the effect of the addition of the second element is weakened depending on the overall composition, and therefore, the density of a sintered body to be produced is not sufficiently increased. On the other hand, when the content of the second element exceeds the above upper limit, the amount of the second element is too large depending on the overall composition and the ratio of the above-mentioned carbide or the like is too high, and therefore, the densification is deteriorated instead.

As described above, each of the first element and the second element deposits a carbide or the like, however, in the case where an element belonging to group 3A or group 4A is selected as the first element as described above and an element belonging to group 5A is selected as the second element as described above, it is presumed that when the metal powder is sintered, the timing when a carbide or the like of the first element is deposited and the timing when a carbide or the like of the second element is deposited differ from each other. It is considered that due to the difference in timing when a carbide or the like is deposited in this manner, sintering gradually proceeds so that the generation of pores is prevented, and thus, a dense sintered body is obtained. That is, it is considered that by the existence of both of the carbide or the like of the first element and the carbide or the like of the second element, the increase in the size of crystal grains can be suppressed while increasing the density of the sintered body.

Further, it is preferred to set the ratio of the content of the first element to the content of the second element in consideration of the mass number of the element selected as the first element and the mass number of the element selected as the second element.

Specifically, when a value obtained by dividing the content E1 (mass %) of the first element by the mass number of the first element is represented by an index X1 and a value obtained by dividing the content E2 (mass %) of the second element by the mass number of the second element is represented by an index X2, the ratio X1/X2 of the index X1 to the index X2 is preferably 0.3 or more and 3 or less, more preferably 0.5 or more and 2 or less, further more preferably 0.75 or more and 1.3 or less. By setting the ratio X1/X2 within the above range, a difference between the timing when a carbide or the like of the first element is deposited and the timing when a carbide or the like of the second element is deposited can be optimized. According to this, pores remaining in a molded body can be eliminated as if they were swept out sequentially from the inside, and therefore, pores generated in a sintered body can be minimized. Therefore, by setting the ratio X1/X2 within the above range, a sintered body having a high density and excellent mechanical properties can be obtained. Further, the balance between the number of atoms of the first element and the number of atoms of the second element is optimized, and therefore, an effect brought about by the first element and an effect brought about by the second element are synergistically exhibited, and thus, a sintered body having a particularly high density can be obtained.

Here, with respect to specific examples of the combination of the first element with the second element, based on the above-mentioned range of the ratio X1/X2, the ratio E1/E2 of the content E1 (mass %) to the content E2 (mass %) is also calculated.

For example, in the case where the first element is Zr and the second element is Nb, since the mass number of Zr is 91.2 and the mass number of Nb is 92.9, E1/E2 is preferably 0.29 or more and 2.95 or less, more preferably 0.49 or more and 1.96 or less.

In the case where the first element is Hf and the second element is Nb, since the mass number of Hf is 178.5 and the mass number of Nb is 92.9, E1/E2 is preferably 0.58 or more and 5.76 or less, more preferably 0.96 or more and 3.84 or less.

In the case where the first element is Ti and the second element is Nb, since the mass number of Ti is 47.9 and the mass number of Nb is 92.9, E1/E2 is preferably 0.15 or more and 1.55 or less, more preferably 0.26 or more and 1.03 or less.

In the case where the first element is Nb and the second element is Ta, since the mass number of Nb is 92.9 and the mass number of Ta is 180.9, E1/E2 is preferably 0.15 or more and 1.54 or less, more preferably 0.26 or more and 1.03 or less.

In the case where the first element is Y and the second element is Nb, since the mass number of Y is 88.9 and the mass number of Nb is 92.9, E1/E2 is preferably 0.29 or more and 2.87 or less, more preferably 0.48 or more and 1.91 or less.

In the case where the first element is V and the second element is Nb, since the mass number of V is 50.9 and the mass number of Nb is 92.9, E1/E2 is preferably 0.16 or more and 1.64 or less, more preferably 0.27 or more and 1.10 or less.

In the case where the first element is Ti and the second element is Zr, since the mass number of Ti is 47.9 and the mass number of Zr is 91.2, E1/E2 is preferably 0.16 or more and 1.58 or less, more preferably 0.26 or more and 1.05 or less.

In the case where the first element is Zr and the second element is Ta, since the mass number of Zr is 91.2 and the mass number of Ta is 180.9, E1/E2 is preferably 0.15 or more and 1.51 or less, more preferably 0.25 or more and 1.01 or less.

In the case where the first element is Zr and the second element is V, since the mass number of Zr is 91.2 and the mass number of V is 50.9, E1/E2 is preferably 0.54 or more and 5.38 or less, more preferably 0.90 or more and 3.58 or less.

Also for combinations other than the above-mentioned combinations, E1/E2 can be calculated in the same manner as described above.

The sum (E1+E2) of the content E1 of the first element and the content E2 of the second element is preferably 0.05 mass % or more and 0.6 mass % or less, more preferably 0.10 mass % or more and 0.48 mass % or less, further more preferably 0.12 mass % or more and 0.24 mass % or less. By setting the sum of the content of the first element and the content of the second element within the above range, the densification of a sintered body to be produced becomes necessary and sufficient.

When the ratio of the sum of the content of the first element and the content of the second element to the content of Si is represented by (E1+E2)/Si, (E1+E2)/Si is preferably 0.1 or more and 0.7 or less, more preferably 0.15 or more and 0.6 or less, further more preferably 0.2 or more and 0.5 or less. By setting (E1+E2)/Si within the above range, a decrease in the toughness or the like when Si is added is sufficiently compensated by the addition of the first element and the second element. As a result, a sintered body which has excellent mechanical properties such as toughness in spite of having a high density and also has excellent corrosion resistance attributed to Si is obtained.

In addition, it is considered that by the addition of appropriate amounts of the first element and the second element, the carbide or the like of the first element and the carbide or the like of the second element act as “nuclei”, and therefore, silicon oxide is accumulated at a crystal grain boundary in the sintered body. By the accumulation of silicon oxide at a crystal grain boundary, the concentration of oxides inside the crystal grain is decreased, and therefore, sintering is promoted. As a result, it is considered that the densification of the sintered body is further promoted.

The deposited silicon oxide easily moves to a grain boundary triple point in the process of accumulation, and therefore, the crystal growth is suppressed at this point (a flux pinning effect). As a result, significant growth of crystal grains is suppressed, and thus, a sintered body having finer crystals is obtained. Such a sintered body has particularly high mechanical properties.

Further, when the ratio of the sum of the content of the first element and the content of the second element to the content of C is represented by (E1+E2)/C, (E1+E2)/C is preferably 1 or more and 16 or less, more preferably 2 or more and 13 or less, further more preferably 3 or more and 10 or less. By setting (E1+E2)/C within the above range, an increase in the hardness and a decrease in the toughness when Cis added and an increase in the density brought about by the addition of the first element and the second element can be all achieved simultaneously. As a result, a sintered body having excellent mechanical properties such as tensile strength and toughness is obtained.

The sintered body may contain two elements selected from the group consisting of Ti, V, Y, Zr, Nb, Hf, and Ta, but may further contain an element which is selected from this group and is different from these two elements. That is, the sintered body may contain three or more elements selected from the group. According to this, the above-mentioned effect can be further enhanced, which slightly varies depending on the combination of the elements to be contained.

A region with a thickness (depth) of 200 μm from the surface of this sintered body as a starting point is defined as “surface layer”.

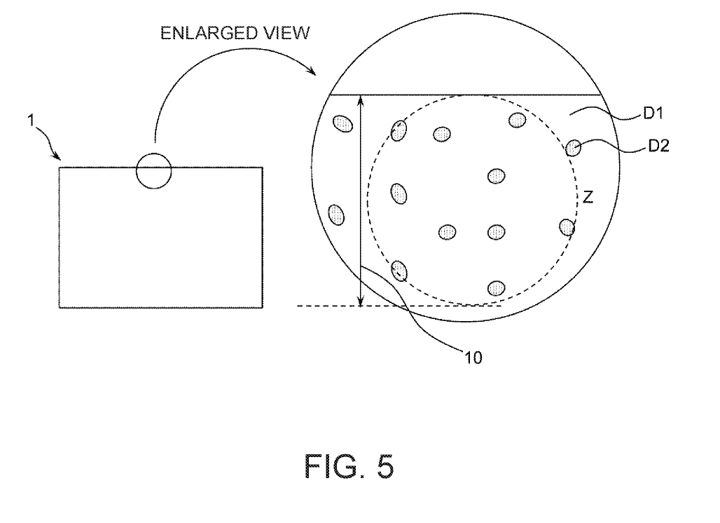

Here, FIG. 5 is a schematic view showing a cross section of a surface layer of a sintered body to be used in the embodiment of the ornament according to the invention.

In a sintered body 1 shown in FIG. 5, in the cross section of a surface layer 10, a region in which Fe is contained as a major component is defined as a first region D1, and a region in which Si or O is contained as a major component is defined as a second region D2. Further, the area ratio of the first region D1 in the cross section of the surface layer is represented by P1, and the area ratio of the second region D2 in the cross section of the surface layer is represented by P2.

At this time, the sintered body satisfies the condition that P2/(P1+P2) is 0.3% or less. Further, the sintered body preferably satisfies the condition that P2/(P1+P2) is 0.1% or less, more preferably satisfies the condition that P2/(P1+P2) is 0.05% or less.

In such a sintered body, particularly, the content of pores or foreign substances in the surface layer is decreased. Therefore, even if the surface is polished, the number or size of pores or foreign substances to be exposed is suppressed, and thus, the adverse effect of the pores or foreign substances on the aesthetic appearance can be minimized. As a result, a sintered body whose polished surface has excellent aesthetic appearance is obtained. Such a sintered body contributes to the improvement of the aesthetic appearance of an ornament.

In other words, a sintered body in the related art satisfies the condition that P2/(P1+P2) exceeds 0.3%. In such a sintered body, the second region D2 contained in a relatively large amount inhibits the densification of the sintered body, and therefore, the sintered body contains pores in a relatively large amount. Due to this, when the surface is polished, these pores are exposed in a large amount, and thus, the aesthetic appearance of an ornament is impaired.

In addition, the density of the sintered body as described above is increased, and therefore, the sintered body has excellent mechanical properties. Due to this, the abrasion resistance and durability of an ornament can be further enhanced.

Each of the first region D1 and the second region D2 is determined by the shades of an electron micrograph of the cross section of the sintered body and also by a qualitative and quantitative analysis.

The shape of the second region D2 in the cross section of the sintered body may be any shape, but is preferably a circular shape. By including such a second region D2, the mechanical properties of the sintered body can be further enhanced. Incidentally, the circular shape includes a true circle, an elongated circle, an ellipse, and the like.

By including the second region D2 at a predetermined ratio or more, the surface layer is sufficiently densified, and thus, a sintered body whose polished surface has excellent aesthetic appearance is obtained. Such a sintered body contributes to the improvement of the aesthetic appearance of an ornament.

In the first region D1, the content of Fe is the highest among all the elements. Therefore, the composition of the first region D1 substantially takes over the composition of the above-mentioned sintered body.

On the other hand, in the second region D2, the content of Si or O is the highest among all the elements. Therefore, a possibility that in the second region D2, Si and O are present in the form of silicon oxide is high.

The composition of each region can be easily determined by utilizing a mapping analysis among the qualitative and quantitative analyses such as, for example, an energy dispersive X-ray analysis.

Each of the area ratio of the first region D1 and the area ratio of the second region D2 in the surface layer 10 is obtained in a circle Z with a radius of 100 μm when the circle Z is drawn in the cross section of the surface layer 10 (see FIG. 5).

The area ratio P1 in the surface layer 10 is preferably 90% or more, more preferably 95% or more. According to this, the first region D1 becomes dominant, and thus, the properties of the sintered body become favorable. In the surface layer 10, a region other than the first region D1 and the second region D2 may be included.

The content of Fe in the first region D1 is preferably 0.5 times or more and 1.5 times or less, more preferably 0.8 times or more and 1.2 times or less of the content of Fe in the entire sintered body 1.

On the other hand, the content of the major component element (Si or O) in the second region D2 is preferably 30 mass % or more, more preferably 40 mass % or more, further more preferably 50 mass % or more.

Further, in the sintered body, a region inside the surface layer is defined as “inner part”. In the cross section of the inner part, the sintered body preferably satisfies the condition that P2/(P1+P2) is more than 0.3% and 10% or less, more preferably satisfies the condition that P2/(P1+P2) is 0.5% or more and 7% or less, further more preferably satisfies the condition that P2/(P1+P2) is 1% or more and 5% or less. By making the inner part of the sintered body satisfy such a condition, a balance of stress between the inner part and the surface layer is achieved. As a result, the densification of the surface layer and the mechanical properties of the sintered body can be achieved simultaneously. That is, when the surface layer is highly densified, the sintered body is likely to be affected by residual stress, however, by making the inner part satisfy the above-mentioned condition, the influence of residual stress on the sintered body can be suppressed. As a result, although the surface layer is highly densified, a sintered body having excellent mechanical properties can be obtained.

Further, P2/(P1+P2) in the inner part is larger than P2/(P1+P2) in the surface layer by preferably 1% or more, more preferably 1.5% or more, further more preferably 2% or more. By having such an area ratio difference (occupancy difference), the effect of alleviating the influence of residual stress described above by the inner part is enhanced. As a result, although the surface layer is highly densified, a sintered body having more excellent mechanical properties can be obtained.

The upper limit of the area ratio difference is set to preferably about 10%, more preferably about 7%. According to this, a balance between the surface layer and the inner part is achieved, and the mechanical properties of the sintered body can be further enhanced.

Further, each of the area ratio of the first region D1 and the area ratio of the second region D2 in the inner part is obtained in a circle with a radius of 100 μm when the circle is drawn centered on a position of 5 mm in depth from the surface in the cross section of the sintered body.

The area ratio P1 in the inner part is preferably 90% or more, more preferably 95% or more. According to this, the first region D1 becomes dominant, and thus, the properties of the sintered body become favorable. Also in the inner part, a region other than the first region D1 and the second region D2 may be included.

The sintered body to be used in the invention may contain, other than the above-mentioned elements, at least one element of Mn, Mo, Cu, N, and S as needed. These elements may be inevitably contained in some cases.

Mn is an element which imparts corrosion resistance and high mechanical properties to a sintered body to be produced in the same manner as Si.

The content of Mn in the sintered body is not particularly limited, but is preferably 0.01 mass % or more and 3 mass % or less, more preferably 0.05 mass % or more and 1 mass % or less. By setting the content of Mn within the above range, a sintered body having a high density and excellent mechanical properties is obtained.

When the content of Mn is less than the above lower limit, the corrosion resistance and the mechanical properties of a sintered body to be produced may not be sufficiently enhanced depending on the overall composition. On the other hand, when the content of Mn exceeds the above upper limit, the corrosion resistance and the mechanical properties may be deteriorated instead.

Mo is an element which enhances the corrosion resistance of a sintered body to be produced.

The content of Mo in the sintered body is not particularly limited, but is preferably 1 mass % or more and 5 mass % or less, more preferably 1.2 mass % or more and 4 mass % or less, further more preferably 2 mass % or more and 3 mass % or less. By setting the content of Mo within the above range, the corrosion resistance of a sintered body to be produced can be further enhanced without causing a large decrease in the density of the sintered body.

Cu is an element which enhances the corrosion resistance of a sintered body to be produced.

The content of Cu in the sintered body is not particularly limited, but is preferably 5 mass % or less, more preferably 1 mass % or more and 4 mass % or less. By setting the content of Cu within the above range, the corrosion resistance of a sintered body to be produced can be further enhanced without causing a large decrease in the density of the sintered body.

N is an element which enhances the mechanical properties such as proof stress of a sintered body to be produced.

The content of N in the sintered body is not particularly limited, but is preferably 0.03 mass % or more and 1 mass % or less, more preferably 0.08 mass % or more and 0.3 mass % or less, further more preferably 0.1 mass % or more and 0.25 mass % or less. By setting the content of N within the above range, the mechanical properties such as proof stress of a sintered body to be produced can be further enhanced without causing a large decrease in the density of the sintered body.

As a method for producing a sintered body to which N is added, in a powder metallurgy method, for example, a method using a metal powder produced using a nitrided raw material, a method using a metal powder produced while introducing nitrogen gas into a molten metal, a method using a metal powder produced by undergoing a nitriding treatment, or the like can be used.

S is an element which enhances the machinability of a sintered body to be produced.

The content of S in the sintered body is not particularly limited, but is preferably 0.5 mass % or less, more preferably 0.01 mass % or more and 0.3 mass % or less . By setting the content of S within the above range, the machinability of a sintered body to be produced can be further enhanced without causing a large decrease in the density of the sintered body.

To the sintered body to be used in the invention, W, Co, B, Se, Te, Pd, Al, or the like may be added other than the above-mentioned elements. At this time, the contents of these elements are not particularly limited, but the content of each of these elements is preferably less than 0.1 mass %, and even the total content of these elements is preferably less than 0.2 mass %. These elements may be inevitably contained in some cases.

The sintered body to be used in the invention may contain impurities. Examples of the impurities include all elements other than the above-mentioned elements, and specific examples thereof include Li, Be, Na, Mg, P, K, Ca, Sc, Zn, Ga, Ge, Ag, In, Sn, Sb, Os, Ir, Pt, Au, and Bi. The incorporation amounts of these impurity elements are preferably set such that the content of each of the impurity elements is less than the content of each of Fe, Cr, Ni, Si, the first element, and the second element. Further, the incorporation amounts of these impurity elements are preferably set such that the content of each of the impurity elements is less than 0.03 mass %, more preferably less than 0.02 mass %. Further, even the total content of these impurity elements is set to preferably less than 0.3 mass %, more preferably less than 0.2 mass %. These elements do not inhibit the effect as described above as long as the contents thereof are within the above range, and therefore may be intentionally added to the sintered body.

Meanwhile, O (oxygen) may also be intentionally added to or inevitably incorporated in the sintered body, however, the amount thereof is preferably about 0.8 mass % or less, more preferably about 0.5 mass % or less. By controlling the amount of oxygen in the sintered body within the above range, the sinterability is enhanced, and thus, a sintered body having a high density and excellent mechanical properties is obtained. Incidentally, the lower limit thereof is not particularly set, but is preferably 0.03 mass % or more from the viewpoint of ease of mass production or the like.

Fe is a component (major component) whose content is the highest in the alloy constituting the sintered body to be used in the invention and has a great influence on the properties of the sintered body. The content of Fe is not particularly limited, but is preferably 50 mass % or more.

The compositional ratio of the sintered body can be determined by, for example, Iron and steel—Atomic absorption spectrometric method specified in JIS G 1257 (2000), Iron and steel—ICP atomic emission spectrometric method specified in JIS G 1258 (2007), Iron and steel—Method for spark discharge atomic emission spectrometric analysis specified in JIS G 1253 (2002), Iron and steel—Method for X-ray fluorescence spectrometric analysis specified in JIS G 1256 (1997), gravimetric, titrimetric, and absorption spectrometric methods specified in JIS G 1211 to G 1237, or the like. Specifically, for example, an optical emission spectrometer for solids (spark optical emission spectrometer, model: SPECTROLAB, type: LAVMBO8A) manufactured by SPECTRO Analytical Instruments GmbH or an ICP device (model: CIROS-120) manufactured by Rigaku Corporation can be used.

Incidentally, the methods specified in JIS G 1211 to G 1237 are as follows.

JIS G 1211 (2011): Iron and steel—Methods for determination of carbon content

JIS G 1212 (1997): Iron and steel—Methods for determination of silicon content

JIS G 1213 (2001): Iron and steel—Methods for determination of manganese content

JIS G 1214 (1998): Iron and steel—Methods for determination of phosphorus content

JIS G 1215 (2010): Iron and steel—Methods for determination of sulfur content

JIS G 1216 (1997): Iron and steel—Methods for determination of nickel content

JIS G 1217 (2005): Iron and steel—Methods for determination of chromium content

JIS G 1218 (1999): Iron and steel—Methods for determination of molybdenum content

JIS G 1219 (1997): Iron and steel—Methods for determination of copper content

JIS G 1220 (1994): Iron and steel—Methods for determination of tungsten content

JIS G 1221 (1998): Iron and steel—Methods for determination of vanadium content

JIS G 1222 (1999): Iron and steel—Methods for determination of cobalt content

JIS G 1223 (1997): Iron and steel—Methods for determination of titanium content

JIS G 1224 (2001): Iron and steel—Methods for determination of aluminum content

JIS G 1225 (2006): Iron and steel—Methods for determination of arsenic content

JIS G 1226 (1994): Iron and steel—Methods for determination of tin content

JIS G 1227 (1999): Iron and steel—Methods for determination of boron content

JIS G 1228 (2006): Iron and steel—Methods for determination of nitrogen content

JIS G 1229 (1994): Steel—Methods for determination of lead content

JIS G 1232 (1980): Methods for determination of zirconium in steel

JIS G 1233 (1994): Steel—Method for determination of selenium content

JIS G 1234 (1981): Methods for determination of tellurium in steel

JIS G 1235 (1981): Methods for determination of antimony in iron and steel

JIS G 1236 (1992): Method for determination of tantalum in steel

JIS G 1237 (1997): Iron and steel- Methods for determination of niobium content

Further, when C (carbon) and S (sulfur) are determined, particularly, an infrared absorption method after combustion in a current of oxygen (after combustion in a high-frequency induction heating furnace) specified in JIS G 1211 (2011) is also used. Specifically, a carbon-sulfur analyzer, CS-200 manufactured by LECO Corporation can be used.

Further, when N (nitrogen) and O (oxygen) are determined, particularly, a method for determination of nitrogen content in iron and steel specified in JIS G 1228 (2006) and a method for determination of oxygen content in metallic materials specified in JIS Z 2613 (2006) are also used. Specifically, an oxygen-nitrogen analyzer, TC-300/EF-300 manufactured by LECO Corporation can be used.

The sintered body to be used in the invention preferably has an austenite crystal structure. The austenite crystal structure imparts high corrosion resistance and also large elongation to a sintered body. Due to this, the sintered body having such a crystal structure is capable of producing a sintered body having high corrosion resistance and large elongation in spite of having a high density. Accordingly, an ornament having high corrosion resistance and also excellent impact resistance can be obtained.

It can be determined whether or not the sintered body has an austenite crystal structure by, for example, X-ray diffractometry.

### Method for Producing Sintered Body

Next, a method for producing such a sintered body to be used for the ornament according to the invention will be described.

The method for producing the sintered body includes (A) a composition preparation step in which a composition for producing a sintered body is prepared, (B) a molding step in which a molded body is produced, (C) a degreasing step in which a degreasing treatment is performed, and (D) a firing step in which firing is performed. Hereinafter, the respective steps will be described sequentially.

### (A) Composition Preparation Step

First, a metal powder for powder metallurgy and a binder are prepared, and these materials are kneaded using a kneader, whereby a kneaded material is obtained. In this kneaded material, the metal powder for powder metallurgy is uniformly dispersed.

The metal powder for powder metallurgy is produced by melting a raw material having the alloy composition of the above-mentioned sintered body, and powdering the obtained molten metal by, for example, any of a variety of powdering methods such as an atomization method (such as a water atomization method, a gas atomization method, or a spinning water atomization method), a reducing method, a carbonyl method, and a pulverization method.

Among these, the metal powder for powder metallurgy to be used in the invention is preferably a metal powder produced by an atomization method, more preferably a metal powder produced by a water atomization method or a spinning water atomization method. The atomization method is a method in which a molten metal (metal melt) is caused to collide with a fluid (liquid or gas) sprayed at a high speed to atomize the metal melt into a fine powder and also to cool the fine powder, whereby a metal powder is produced. By producing the metal powder for powder metallurgy through such an atomization method, an extremely fine powder can be efficiently produced. Further, the shape of the particle of the obtained powder is closer to a spherical shape by the action of surface tension. Therefore, a metal powder having a high packing factor at the time of molding is obtained. That is, a powder capable of producing a sintered body having a high density can be obtained.

The metal powder for powder metallurgy may be one type of powder produced by melting and powdering a raw material having the alloy composition of the above-mentioned sintered body, but may be a mixture of two or more types of powders having different compositions. In the case of the latter, the compositions of the respective powders are adjusted so as to have the alloy composition of the above-mentioned sintered body in the mixture as a whole. In other words, the latter is a pre-mix powder obtained by pre-mixing two or more types of powders, and the former is a pre-alloy powder. Therefore, the above-mentioned sintered body can be produced by a powder metallurgy method using a pre-alloy powder or by a powder metallurgy method using a pre-mix powder.

Among these, the respective compositions of two or more types of powders in the pre-mix powder are not particularly limited. For example, a mixed powder in which a powder having a composition excluding C (carbon) from the alloy composition of the above-mentioned sintered body is prepared as one powder (first powder) and a powder of C is prepared as the other powder (second powder), and these powders are mixed with each other, a mixed powder in which a powder having a composition excluding part of C from the alloy composition of the above-mentioned sintered body is prepared as one powder (first powder) and the part of C excluded in the first powder is prepared as the other powder (second powder), and these powders are mixed with each other, and the like are exemplified. By using such a pre-mix powder, a carbide or the like of the first element or the second element is easily deposited in the surface layer of the sintered body. Due to this, particularly, significant growth of crystal grains in the surface layer is inhibited, so that pores are hardly generated in the surface layer. As a result, particularly, the increase in the size of crystal grains in the surface layer is prevented, and thus, the density of the sintered body is increased.

Further, in such a pre-mix powder, the magnitude relationship between the particle diameter of the first powder and the particle diameter of the second powder is not particularly limited. Therefore, the average particle diameter of the second powder may be larger than or equal to the average particle diameter of the first powder, however, the average particle diameter of the second powder is preferably smaller than the average particle diameter of the first powder. According to this, the second powder can be uniformly dispersed among the particles of the first powder, so that significant growth of crystal grains among the particles can be particularly suppressed. As a result, pores which are easily generated at a grain boundary triple point can be particularly reduced, and thus, particularly, the density can be increased in the surface layer of the sintered body.

Examples of a method for mixing two or more types of powders include a mixing machine, a mill, and a mixer. Among these, in the case of using a mixing machine, the rotation speed is set to, for example, about 10 rpm or more and 200 rpm or less, and the mixing time is set to, for example, about 100 sec or more and 10000 sec or less.

On the other hand, in the case of the former (pre-alloy powder), by adjusting the temperature of the molten metal when it is powdered, the same action and effect as in the case of a pre-mix powder are exhibited. That is, the pre-alloy powder produced while optimizing the temperature of the molten metal facilitates the deposition of a carbide or the like of the first element or the second element in the surface layer of the sintered body in the same manner as in the case of using a pre-mix powder. Due to this, particularly, significant growth of crystal grains in the surface layer is inhibited, and thus, pores are hardly generated in the surface layer.

Specifically, when the melting point of the raw material is represented by Tm, the temperature of the molten metal when it is powdered is preferably Tm+30° C. or higher and Tm+200° C. or lower, more preferably Tm+40° C. or higher and Tm+100° C. or lower. The viscosity of the molten metal when it is powdered can be decreased, and therefore, C (carbon) which is a light element is likely to migrate to the surface of the particle. As a result, a carbide or the like of the first element or the second element is easily deposited in the surface layer of the sintered body in the same manner as in the case of a pre-mix powder.

Meanwhile, examples of the binder include polyolefins such as polyethylene, polypropylene, and ethylene-vinyl acetate copolymers, acrylic resins such as polymethyl methacrylate and polybutyl methacrylate, styrenic resins such as polystyrene, polyesters such as polyvinyl chloride, polyvinylidene chloride, polyamide, polyethylene terephthalate, and polybutylene terephthalate, various resins such as polyether, polyvinyl alcohol, polyvinylpyrrolidone, and copolymers thereof, and various organic binders such as various waxes, paraffins, higher fatty acids (such as stearic acid), higher alcohols, higher fatty acid esters, and higher fatty acid amides. These can be used alone or by mixing two or more types thereof.

The content of the binder is preferably about 2 mass % or more and 20 mass % or less, more preferably about 5 mass % or more and 10 mass % or less with respect to the total amount of the kneaded material. By setting the content of the binder within the above range, a molded body can be formed with good moldability, and also the density is increased, whereby the stability of the shape of the molded body and the like can be particularly enhanced. Further, according to this, a difference in size between the molded body and the degreased body, that is, so-called a shrinkage ratio is optimized, whereby a decrease in the dimensional accuracy of the finally obtained sintered body can be prevented. That is, a sintered body having a high density and high dimensional accuracy can be obtained.

In the kneaded material, a plasticizer may be added as needed. Examples of the plasticizer include phthalate esters (such as DOP, DEP, and DBP), adipate esters, trimellitate esters, and sebacate esters. These can be used alone or by mixing two or more types thereof.

Further, in the kneaded material, other than the metal powder for powder metallurgy, the binder, and the plasticizer, for example, any of a variety of additives such as a lubricant, an antioxidant, a degreasing accelerator, and a surfactant can be added as needed.

The kneading conditions vary depending on the respective conditions such as the metal composition or the particle diameter of the metal powder for powder metallurgy to be used, the composition of the binder, and the blending amount thereof. However, for example, the kneading temperature can be set to about 50° C. or higher and 200° C. or lower, and the kneading time can be set to about 15 minutes or more and 210 minutes or less.

Further, the kneaded material is formed into pellets (small particles) as needed. The particle diameter of the pellet is set to, for example, about 1 mm or more and 15 mm or less.

Incidentally, depending on the molding method described below, in place of the kneaded material, a granulated powder may be produced. The kneaded material, the granulated powder, and the like are examples of the composition to be subjected to the molding step described below.

### (B) Molding Step

Subsequently, the kneaded material or the granulated powder is molded, whereby a molded body having the same shape as that of a target sintered body is produced.

The method for producing a molded body (molding method) is not particularly limited, and for example, any of a variety of molding methods such as a powder compacting (compression molding) method, a metal injection molding (MIM) method, and an extrusion molding method can be used.

The molding conditions in the case of a powder compacting method among these methods are preferably such that the molding pressure is about 200 MPa or more and 1000 MPa or less (2 t/cm² or more and 10 t/cm² or less), which vary depending on the respective conditions such as the composition and the particle diameter of the metal powder for powder metallurgy to be used, the composition of the binder, and the blending amount thereof.

The molding conditions in the case of a metal injection molding method are preferably such that the material temperature is about 80° C. or higher and 210° C. or lower, and the injection pressure is about 50 MPa or more and 500 MPa or less (0.5 t/cm² or more and 5 t/cm² or less), which vary depending on the respective conditions.

The molding conditions in the case of an extrusion molding method are preferably such that the material temperature is about 80° C. or higher and 210° C. or lower, and the extrusion pressure is about 50 MPa or more and 500 MPa or less (0.5 t/cm² or more and 5 t/cm² or less), which vary depending on the respective conditions.

The thus obtained molded body is in a state where the binder is uniformly distributed in spaces between the particles of the metal powder.

The shape and size of the molded body to be produced are determined in anticipation of shrinkage of the molded body in the subsequent degreasing step and firing step.

### (C) Degreasing Step

Subsequently, the thus obtained molded body is subjected to a degreasing treatment (binder removal treatment), whereby a degreased body is obtained.

Specifically, the binder is decomposed by heating the molded body, whereby the binder is removed from the molded body. In this manner, the degreasing treatment is performed.

Examples of the degreasing treatment include a method of heating the molded body and a method of exposing the molded body to a gas capable of decomposing the binder.

In the case of using a method of heating the molded body, the conditions for heating the molded body are preferably such that the temperature is about 100° C. or higher and 750° C. or lower and the time is about 0.1 hours or more and 20 hours or less, and more preferably such that the temperature is about 150° C. or higher and 600° C. or lower and the time is about 0.5 hours or more and 15 hours or less, which slightly vary depending on the composition and the blending amount of the binder. According to this, the degreasing of the molded body can be necessarily and sufficiently performed without sintering the molded body. As a result, it is possible to reliably prevent the binder component from remaining inside the degreased body in a large amount.

The atmosphere when the molded body is heated is not particularly limited, and an atmosphere of a reducing gas such as hydrogen, an atmosphere of an inert gas such as nitrogen or argon, an atmosphere of an oxidative gas such as air, a reduced pressure atmosphere obtained by reducing the pressure of such an atmosphere, or the like can be used.

Examples of the gas capable of decomposing the binder include ozone gas.

Incidentally, by dividing this degreasing step into a plurality of steps in which the degreasing conditions are different, and performing the plurality of steps, the binder in the molded body can be more rapidly decomposed and removed so that the binder does not remain in the molded body.

Further, according to need, the degreased body may be subjected to a machining process such as grinding, polishing, or cutting. The degreased body has a relatively low hardness and relatively high plasticity, and therefore, the machining process can be easily performed while preventing the degreased body from losing its shape. According to such a machining process, a sintered body having high dimensional accuracy can be easily obtained in the end.

### (D) Firing Step

The degreased body obtained in the above step (C) is fired in a firing furnace, whereby a sintered body is obtained.

By this firing, in the metal powder for powder metallurgy, diffusion occurs at the boundary surface between the particles, resulting in sintering. At this time, by the mechanism as described above, the degreased body is rapidly sintered. As a result, a sintered body which is dense and has a high density on the whole is obtained.

The firing temperature varies depending on the composition, the particle diameter, and the like of the metal powder for powder metallurgy used in the production of the molded body and the degreased body, but is set to, for example, about 980° C. or higher and 1330° C. or lower, and preferably set to about 1050° C. or higher and 1260° C. or lower.

Further, the firing time is set to 0.2 hours or more and 7 hours or less, but is preferably set to about 1 hour or more and 6 hours or less.

In the firing step, the firing temperature or the below-described firing atmosphere may be changed in the middle of the step.

By setting the firing conditions within such ranges, it is possible to sufficiently sinter the entire degreased body while preventing the sintering from proceeding excessively to cause oversintering and increase the size of the crystal structure. As a result, a sintered body having a high density and particularly excellent mechanical properties can be obtained.

Further, since the firing temperature is a relatively low temperature, it is easy to control the heating temperature in the firing furnace to be a fixed temperature, and therefore, it is also easy to maintain the temperature of the degreased body at a fixed temperature. As a result, a more homogeneous sintered body can be produced.

Further, since the firing temperature as described above is a firing temperature which can be sufficiently realized using a common firing furnace, and therefore, an inexpensive firing furnace can be used, and also the running cost can be kept low. In other words, in the case where the temperature exceeds the above-mentioned firing temperature, it is necessary to employ an expensive firing furnace using a special heat resistant material, and also the running cost may be increased.

The atmosphere when performing firing is not particularly limited, however, in consideration of prevention of significant oxidation of the metal powder, an atmosphere of a reducing gas such as hydrogen, an atmosphere of an inert gas such as argon, a reduced pressure atmosphere obtained by reducing the pressure of such an atmosphere, or the like is preferably used.

The thus obtained sintered body has a high density and excellent mechanical properties. That is, a sintered body produced by molding a composition containing a metal powder for powder metallurgy and a binder, followed by degreasing and sintering has a higher relative density than a sintered body obtained by sintering a metal powder in the related art. In particular, the formation of pores in the surface layer is suppressed, and therefore, pores are hardly exposed by polishing or the like. As a result, a sintered body whose polished surface has excellent aesthetic appearance is obtained. Such a sintered body contributes to the improvement of the aesthetic appearance of an ornament. Therefore, according to this production method, a sintered body having a high density which could not be obtained unless an additional treatment such as an HIP treatment is performed can be produced without performing an additional treatment.

Specifically, according to the invention, for example, the relative density can be expected to be increased by 2% or more as compared with the related art, which slightly varies depending on the composition of the metal powder for powder metallurgy.

As a result, the relative density of the obtained sintered body can be expected to be, for example, 98% or more (preferably 98.5% or more, more preferably 99% or more). The sintered body having a relative density within such a range has excellent mechanical properties comparable to those of an ingot material although it has a shape as close as possible to a desired shape by using a powder metallurgy technique, and therefore, the sintered body can be applied to a variety of machine parts, structural parts, and the like with virtually no post-processing. Further, in particular, the formation of pores in the surface layer is suppressed, and therefore, pores are hardly exposed by polishing or the like. As a result, a sintered body whose polished surface has excellent aesthetic appearance is obtained. Such a sintered body contributes to the improvement of the aesthetic appearance of an ornament.

Further, the sintered body produced as described above has a high surface hardness. Specifically, as one example, the Vickers hardness of the surface of the sintered body is expected to be 140 or more and 500 or less, which slightly varies depending on the composition of the metal powder for powder metallurgy, and further is expected to be preferably 150 or more and 400 or less. The sintered body having such a hardness has particularly high durability. As a result, an ornament which is hardly scratched on the surface is obtained.

The obtained sintered body may be subjected to any of a variety of quenching treatments, a variety of sub-zero treatments, a variety of tempering treatments, and the like as needed other than an additional treatment of increasing the density such as an HIP treatment.

Hereinabove, the ornament according to the invention has been described with reference to preferred embodiments, however, the invention is not limited thereto.

For example, the ornaments listed above are merely examples, and the invention can be applied also to ornaments other than these.

### EXAMPLES

Next, Examples of the invention will be described.

### 1. Production of Sintered Body (Zr—Nb Based)

### Sample No. 1

(1) First, a mixed powder having a composition shown in Table 1 produced by a water atomization method was prepared. This mixed powder is a powder obtained by mixing a first powder having a composition excluding C (carbon) from the composition shown in Table 1 and a second powder composed of C (carbon) using a mixing machine.

The composition of the powder shown in Table 1 was identified and quantitatively determined by an inductively coupled high-frequency plasma optical emission spectrometry (ICP analysis method). In the ICP analysis, an ICP device (model: CIROS-120) manufactured by Rigaku Corporation was used. Further, in the identification and quantitative determination of C, a carbon-sulfur analyzer (CS-200) manufactured by LECO Corporation was used. Further, in the identification and quantitative determination of 0, an oxygen-nitrogen analyzer (TC-300/EF-300) manufactured by LECO Corporation was used.

(2) Subsequently, the mixed powder and a mixture (organic binder) of polypropylene and a wax were weighed at a mass ratio of 9:1 and mixed with each other, whereby a mixed raw material was obtained.

(3) Subsequently, this mixed raw material was kneaded using a kneader, whereby a compound was obtained.

(4) Subsequently, this compound was molded using an injection molding device under the following molding conditions, whereby a molded body was produced.

### Molding Conditions

Material temperature: 150° C.
Injection pressure: 11 MPa (110 kgf/cm²)

(5) Subsequently, the obtained molded body was subjected to a heat treatment (degreasing treatment) under the following degreasing conditions, whereby a degreased body was obtained.

Degreasing Conditions
Degreasing temperature: 500° C.
Degreasing time: 1 hour (retention time at the degreasing temperature)
Degreasing atmosphere: nitrogen atmosphere

(6) Subsequently, the obtained degreased body was fired under the following firing conditions, whereby a sintered body was obtained. The shape of the sintered body was determined to be a cylindrical shape with a diameter of 10 mm and a thickness of 5 mm.

Firing Conditions
Firing temperature: 1200° C.
Firing time: 3 hours (retention time at the firing temperature)
Firing atmosphere: argon atmosphere

### Sample Nos. 2 to 19

Sintered bodies were obtained in the same manner as the method for producing the sintered body of sample No. 1 except that the composition and the like of the metal powder for powder metallurgy were changed as shown in Table 1, respectively. The sintered body of sample No. 19 was subjected to an HIP treatment under the following conditions after firing.

HIP Treatment Conditions
Heating temperature: 1100° C.
Heating time: 2 hours
Applied pressure: 100 MPa

TABLE 1

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Zr) | (Nb) | Mo | Mn | O | Fe |
| No. | — | mass % | | | | | | | | | |
| No. 1 | Ex. | 16.41 | 12.45 | 0.74 | 0.019 | 0.08 | 0.07 | 2.13 | 0.07 | 0.29 | remainder |
| No. 2 | Ex. | 17.13 | 12.65 | 0.59 | 0.024 | 0.07 | 0.05 | 2.41 | 0.11 | 0.30 | remainder |
| No. 3 | Ex. | 17.85 | 13.22 | 0.66 | 0.028 | 0.06 | 0.10 | 2.02 | 0.08 | 0.41 | remainder |
| No. 4 | Ex. | 16.20 | 14.68 | 0.82 | 0.012 | 0.05 | 0.05 | 2.87 | 0.08 | 0.26 | remainder |
| No. 5 | Ex. | 17.53 | 13.86 | 0.74 | 0.025 | 0.09 | 0.10 | 2.56 | 0.12 | 0.35 | remainder |
| No. 6 | Ex. | 16.77 | 11.56 | 0.51 | 0.067 | 0.12 | 0.03 | 2.72 | 0.13 | 0.23 | remainder |
| No. 7 | Ex. | 17.50 | 13.23 | 0.70 | 0.053 | 0.03 | 0.12 | 2.16 | 0.78 | 0.39 | remainder |
| No. 8 | Ex. | 16.86 | 14.13 | 0.76 | 0.022 | 0.23 | 0.10 | 2.21 | 0.27 | 0.46 | remainder |
| No. 9 | Ex. | 17.30 | 12.63 | 0.45 | 0.019 | 0.07 | 0.25 | 2.79 | 0.16 | 0.28 | remainder |
| No. 10 | Comp. | 16.32 | 12.82 | 0.74 | 0.024 | 0.00 | 0.06 | 2.34 | 0.12 | 0.31 | remainder |
| | Ex. | | | | | | | | | | |
| No. 11 | Comp. | 17.24 | 13.30 | 0.78 | 0.031 | 0.06 | 0.00 | 2.29 | 0.09 | 0.32 | remainder |
| | Ex. | | | | | | | | | | |
| No. 12 | Comp. | 16.73 | 14.21 | 0.74 | 0.016 | 0.00 | 0.00 | 2.31 | 0.13 | 0.34 | remainder |
| | Ex. | | | | | | | | | | |
| No. 13 | Comp. | 16.44 | 12.43 | 0.86 | 0.019 | 0.66 | 0.06 | 2.56 | 0.12 | 0.37 | remainder |
| | Ex. | | | | | | | | | | |
| No. 14 | Comp. | 16.36 | 13.02 | 0.64 | 0.034 | 0.05 | 0.69 | 2.32 | 0.06 | 0.39 | remainder |
| | Ex. | | | | | | | | | | |
| No. 15 | Comp. | 17.54 | 13.23 | 0.13 | 0.012 | 0.08 | 0.08 | 2.79 | 0.13 | 0.28 | remainder |
| | Ex. | | | | | | | | | | |
| No. 16 | Comp. | 17.65 | 13.55 | 1.89 | 0.063 | 0.04 | 0.08 | 2.88 | 0.31 | 0.42 | remainder |
| | Ex. | | | | | | | | | | |
| No. 17 | Comp. | 17.54 | 13.23 | 0.64 | 0.002 | 0.01 | 0.01 | 2.75 | 0.11 | 0.27 | remainder |
| | Ex. | | | | | | | | | | |
| No. 18 | Comp. | 17.58 | 13.23 | 0.36 | 0.380 | 0.22 | 0.07 | 2.69 | 0.25 | 0.46 | remainder |
| | Ex. | | | | | | | | | | |
| No. 19 | Comp. | 16.35 | 12.86 | 0.76 | 0.026 | 0.00 | 0.08 | 2.35 | 0.12 | 0.31 | remainder |
| | Ex. | | | | | | | | | | |

| | | | | | | | Sintered body | | | |
|---|---|---|---|---|---|---|---|---|---|---|
| | | Metal powder for powder metallurgy | | | | | Surface | Inner | | |
| | | | | | | Powder | layer | part | | |
| | | | | (E1 + E2)/ | (E1 + E2)/ | production | P2/ | P2/ | Area ratio | |
| Sample | | E1/E2 | E1 + E2 | Si | C | method | (P1 + P2) | (P1 + P2) | difference | Remarks |
| No. | — | — | mass % | — | — | — | % | % | % | — |
| No. 1 | Ex. | 1.14 | 0.15 | 0.20 | 7.89 | Pre-mix | 0.01 | 2.89 | 2.88 | |
| No. 2 | Ex. | 1.40 | 0.12 | 0.20 | 5.00 | Pre-mix | 0.02 | 2.78 | 2.76 | |
| No. 3 | Ex. | 0.60 | 0.16 | 0.24 | 5.71 | Pre-mix | 0.04 | 3.01 | 2.97 | |
| No. 4 | Ex. | 1.00 | 0.10 | 0.12 | 8.33 | Pre-mix | 0.05 | 3.52 | 3.47 | |
| No. 5 | Ex. | 0.90 | 0.19 | 0.26 | 7.60 | Pre-mix | 0.06 | 3.23 | 3.17 | |
| No. 6 | Ex. | 4.00 | 0.15 | 0.29 | 2.24 | Pre-mix | 0.09 | 3.64 | 3.55 | |
| No. 7 | Ex. | 0.25 | 0.15 | 0.21 | 2.83 | Pre-mix | 0.10 | 3.77 | 3.67 | |
| No. 8 | Ex. | 2.30 | 0.33 | 0.43 | 15.00 | Pre-mix | 0.13 | 5.24 | 5.11 | |
| No. 9 | Ex. | 0.28 | 0.32 | 0.71 | 16.84 | Pre-mix | 0.16 | 5.55 | 5.39 | |
| No. 10 | Comp. | 0.00 | 0.06 | 0.08 | 2.50 | Pre-mix | 2.50 | 3.45 | 0.95 | |
| | Ex. | | | | | | | | | |
| No. 11 | Comp. | — | 0.06 | 0.08 | 1.94 | Pre-mix | 1.00 | 3.98 | 2.98 | |
| | Ex. | | | | | | | | | |
| No. 12 | Comp. | — | 0.00 | 0.00 | 0.00 | Pre-mix | 2.82 | 3.25 | 0.43 | |
| | Ex. | | | | | | | | | |
| No. 13 | Comp. | 11.00 | 0.72 | 0.84 | 37.89 | Pre-mix | 0.50 | 3.83 | 3.33 | |
| | Ex. | | | | | | | | | |
| No. 14 | Comp. | 0.07 | 0.74 | 1.16 | 21.76 | Pre-mix | 1.90 | 4.21 | 2.31 | |
| | Ex. | | | | | | | | | |
| No. 15 | Comp. | 1.00 | 0.16 | 1.23 | 13.33 | Pre-mix | 0.90 | 4.88 | 3.98 | |
| | Ex. | | | | | | | | | |
| No. 16 | Comp. | 0.50 | 0.12 | 0.06 | 1.90 | Pre-mix | 3.00 | 5.31 | 2.31 | |
| | Ex. | | | | | | | | | |
| No. 17 | Comp. | 1.00 | 0.02 | 0.03 | 10.00 | Pre-mix | 1.83 | 5.08 | 3.26 | |
| | Ex. | | | | | | | | | |
| No. 18 | Comp. | 3.14 | 0.29 | 0.81 | 0.76 | Pre-mix | 2.36 | 5.43 | 3.07 | |
| | Ex. | | | | | | | | | |
| No. 19 | Comp. | — | 0.08 | 0.11 | 3.08 | Pre-mix | 0.21 | 0.23 | 0.02 | HIP |
| | Ex. | | | | | | | | | treatment |

In Table 1, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 1.

### Sample Nos. 20 to 34

In place of the mixed powder, a metal powder having a composition shown in Table 2 was produced by a water atomization method. Incidentally, the molten metal when it was powdered by a water atomization method was heated to a temperature which was higher than the melting point of the raw material by 50° C.

Subsequently, by using the obtained metal powder and an organic binder, a mixed raw material was obtained and also a sintered body was obtained in the same manner as in the case of sample No. 1. The sintered body of sample No. 34 was subjected to an HIP treatment under the following conditions after firing.

HIP Treatment Conditions
Heating temperature: 1100° C.
Heating time: 2 hours
Applied pressure: 100 MPa

TABLE 2

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Zr) | (Nb) | Mo | Mn | O | Fe |
| No. | — | mass % | | | | | | | | | |
| No. 20 | Ex. | 16.42 | 12.47 | 0.71 | 0.018 | 0.09 | 0.07 | 2.10 | 0.05 | 0.27 | remainder |
| No. 21 | Ex. | 17.10 | 12.61 | 0.56 | 0.021 | 0.07 | 0.05 | 2.42 | 0.11 | 0.29 | remainder |
| No. 22 | Ex. | 17.85 | 13.22 | 0.63 | 0.027 | 0.05 | 0.09 | 2.02 | 0.07 | 0.39 | remainder |
| No. 23 | Ex. | 16.15 | 14.69 | 0.82 | 0.012 | 0.05 | 0.05 | 2.87 | 0.08 | 0.26 | remainder |
| No. 24 | Ex. | 17.56 | 13.89 | 0.76 | 0.027 | 0.09 | 0.10 | 2.59 | 0.09 | 0.35 | remainder |
| No. 25 | Ex. | 16.75 | 11.57 | 0.51 | 0.067 | 0.12 | 0.03 | 2.72 | 0.13 | 0.23 | remainder |
| No. 26 | Ex. | 17.48 | 13.23 | 0.68 | 0.055 | 0.03 | 0.12 | 2.16 | 0.81 | 0.42 | remainder |
| No. 27 | Ex. | 16.69 | 14.18 | 0.78 | 0.025 | 0.24 | 0.09 | 2.24 | 0.29 | 0.51 | remainder |
| No. 28 | Ex. | 17.34 | 12.62 | 0.49 | 0.023 | 0.08 | 0.26 | 2.79 | 0.16 | 0.28 | remainder |
| No. 29 | Comp. | 16.33 | 12.82 | 0.74 | 0.024 | 0.00 | 0.07 | 2.35 | 0.11 | 0.28 | remainder |
| | Ex. | | | | | | | | | | |
| No. 30 | Comp. | 17.21 | 13.30 | 0.78 | 0.031 | 0.05 | 0.00 | 2.26 | 0.10 | 0.29 | remainder |
| | Ex. | | | | | | | | | | |
| No. 31 | Comp. | 16.77 | 14.25 | 0.76 | 0.016 | 0.00 | 0.00 | 2.34 | 0.13 | 0.32 | remainder |
| | Ex. | | | | | | | | | | |
| No. 32 | Comp. | 16.42 | 12.44 | 0.87 | 0.019 | 0.67 | 0.07 | 2.56 | 0.12 | 0.37 | remainder |
| | Ex. | | | | | | | | | | |
| No. 33 | Comp. | 16.36 | 13.02 | 0.65 | 0.033 | 0.06 | 0.72 | 2.35 | 0.06 | 0.41 | remainder |
| | Ex. | | | | | | | | | | |
| No. 34 | Comp. | 16.35 | 12.82 | 0.74 | 0.025 | 0.00 | 0.07 | 2.35 | 0.12 | 0.29 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 20 | 1.29 | 0.16 | 0.23 | 8.89 | Pre-alloy | 0.08 | 3.12 | 3.04 | |
| | | No. 21 | 1.40 | 0.12 | 0.21 | 5.71 | Pre-alloy | 0.08 | 3.23 | 3.15 | |
| | | No. 22 | 0.56 | 0.14 | 0.22 | 5.19 | Pre-alloy | 0.09 | 3.45 | 3.36 | |
| | | No. 23 | 1.00 | 0.10 | 0.12 | 8.33 | Pre-alloy | 0.10 | 3.51 | 3.41 | |
| | | No. 24 | 0.90 | 0.19 | 0.25 | 7.04 | Pre-alloy | 0.13 | 4.01 | 3.88 | |
| | | No. 25 | 4.00 | 0.15 | 0.29 | 2.24 | Pre-alloy | 0.20 | 4.25 | 4.05 | |
| | | No. 26 | 0.25 | 0.15 | 0.22 | 2.73 | Pre-alloy | 0.22 | 4.31 | 4.09 | |
| | | No. 27 | 2.67 | 0.33 | 0.42 | 13.20 | Pre-alloy | 0.25 | 4.45 | 4.20 | |
| | | No. 28 | 0.31 | 0.34 | 0.69 | 14.78 | Pre-alloy | 0.28 | 4.51 | 4.23 | |
| | | No. 29 | 0.00 | 0.07 | 0.09 | 2.92 | Pre-alloy | 2.91 | 3.25 | 0.34 | |
| | | No. 30 | — | 0.05 | 0.06 | 1.61 | Pre-alloy | 1.15 | 3.56 | 2.41 | |
| | | No. 31 | — | 0.00 | 0.00 | 0.00 | Pre-alloy | 3.55 | 3.68 | 0.13 | |
| | | No. 32 | 9.57 | 0.74 | 0.85 | 38.95 | Pre-alloy | 0.91 | 4.12 | 3.21 | |
| | | No. 33 | 0.08 | 0.78 | 1.20 | 23.64 | Pre-alloy | 1.61 | 5.23 | 3.62 | |
| | | No. 34 | — | 0.07 | 0.09 | 2.80 | Pre-alloy | 0.21 | 0.25 | 0.04 | HIP |
| | | | | | | | | | | | treatment |

In Table 2, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 2.

### 2. Evaluation of Sintered Body (Zr—Nb Based)

### 2.1 Evaluation of Relative Density

With respect to the sintered bodies of the respective sample Nos. shown in Tables 1 and 2, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Tables 3 and 4.

### 2.2 Evaluation of Vickers Hardness

With respect to the sintered bodies of the respective sample Nos. shown in Tables 1 and 2, the Vickers hardness was measured in accordance with the Vickers hardness test method specified in JIS Z 2244 (2009).

The measurement results are shown in Tables 3 and 4.

### 2.3 Evaluation of Tensile Strength, 0.2% Proof Stress, and Elongation

With respect to the sintered bodies of the respective sample Nos. shown in Tables 1 and 2, the tensile strength, 0.2% proof stress, and elongation were measured in accordance with the metal material tensile test method specified in JIS Z 2241 (2011).

Then, these measured physical property values were evaluated according to the following evaluation criteria.

Evaluation Criteria for Tensile Strength

A: The tensile strength of the sintered body is 520 MPa or more.

B: The tensile strength of the sintered body is 510 MPa or more and less than 520 MPa.

C: The tensile strength of the sintered body is 500 MPa or more and less than 510 MPa.

D: The tensile strength of the sintered body is 490 MPa or more and less than 500 MPa.

E: The tensile strength of the sintered body is 480 MPa or more and less than 490 MPa.

F: The tensile strength of the sintered body is less than 480 MPa.

### Evaluation Criteria for 0.2% Proof Stress

A: The 0.2% proof stress of the sintered body is 195 MPa or more.

B: The 0.2% proof stress of the sintered body is 190 MPa or more and less than 195 MPa.

C: The 0.2% proof stress of the sintered body is 185 MPa or more and less than 190 MPa.

D: The 0.2% proof stress of the sintered body is 180 MPa or more and less than 185 MPa.

E: The 0.2% proof stress of the sintered body is 175 MPa or more and less than 180 MPa.

F: The 0.2% proof stress of the sintered body is less than 175 MPa.

### Evaluation Criteria for Elongation

A: The elongation of the sintered body is 48% or more.

B: The elongation of the sintered body is 46% or more and less than 48%.

C: The elongation of the sintered body is 44% or more and less than 46%.

D: The elongation of the sintered body is 42% or more and less than 44%.

E: The elongation of the sintered body is 40% or more and less than 42%.

F: The elongation of the sintered body is less than 40%.

The above evaluation results are shown in Tables 3 and 4.

### 2.4 Evaluation of Fatigue Strength

With respect to the sintered bodies of the respective sample Nos. shown in Tables 1 and 2, the fatigue strength was measured.

The fatigue strength was measured in accordance with the test method specified in JIS Z 2273 (1978). The waveform of an applied load corresponding to a repeated stress was set to an alternating sine wave, and the minimum/maximum stress ratio (minimum stress/maximum stress) was set to 0.1. Further, the repeated frequency was set to 30 Hz, and the repeat count was set to 1×10⁷.

Then, the measured fatigue strength was evaluated according to the following evaluation criteria.

### Evaluation Criteria for Fatigue Strength

A: The fatigue strength of the sintered body is 260 MPa or more.

B: The fatigue strength of the sintered body is 240 MPa or more and less than 260 MPa.

C: The fatigue strength of the sintered body is 220 MPa or more and less than 240 MPa.

D: The fatigue strength of the sintered body is 200 MPa or more and less than 220 MPa.

E: The fatigue strength of the sintered body is 180 MPa or more and less than 200 MPa.

F: The fatigue strength of the sintered body is less than 180 MPa.

The above evaluation results are shown in Tables 3 and 4.

### 2.5 Evaluation of Aesthetic Appearance

First, the surface of each of the sintered bodies of the respective sample Nos. shown in Tables 1 and 2 was subjected to a polishing treatment. As the polishing treatment, a treatment in which the sintered body was polished sequentially with a 400 grit abrasive, a 600 grit abrasive, and a 800 grit abrasive was performed.

Subsequently, with respect to the surface of each of the sintered bodies after being polished, the specular glossiness was measured in accordance with the specular glossiness measurement method specified in JIS Z 8741 (1997). The angle of incidence of light with respect to the surface of the sintered body was set to 60°, and as the reference plane for calculating the specular glossiness, glass having a specular glossiness of 90 and a refractive index of 1.500 was used. Then, the measured specular glossiness was evaluated according to the following evaluation criteria.

### Evaluation Criteria for Specular Glossiness (Aesthetic Appearance)

A: The specularity of the surface is very high (the specular glossiness is 200 or more).

B: The specularity of the surface is high (the specular glossiness is 150 or more and less than 200).

C: The specularity of the surface is slightly high (the specular glossiness is 100 or more and less than 150).

D: The specularity of the surface is slightly low (the specular glossiness is 60 or more and less than 100).

E: The specularity of the surface is low (the specular glossiness is 30 or more and less than 60).

D: The specularity of the surface is very low (the specular glossiness is less than 30).

The above evaluation results are shown in Tables 3 and 4.

TABLE 3

| | | Metal | | | | | | | |
|---|---|---|---|---|---|---|---|---|---|
| | | powder | Evaluation results of sintered body | | | | | | |
| | | Average | | | | 0.2% | | | |
| | | particle | Relative | Vickers | Tensile | proof | | Fatigue | Aesthetic |
| Sample | | diameter | density | hardness | strength | stress | Elongation | strength | appearance |
| No. | — | μm | % | — | — | — | — | — | — |
| No. 1 | Ex. | 4.09 | 99.6 | 166 | A | A | A | A | A |
| No. 2 | Ex. | 3.82 | 99.7 | 177 | A | A | A | A | A |
| No. 3 | Ex. | 3.86 | 99.4 | 173 | A | A | A | A | A |
| No. 4 | Ex. | 4.02 | 98.9 | 156 | B | A | A | A | A |
| No. 5 | Ex. | 4.58 | 99.8 | 186 | A | A | A | A | A |
| No. 6 | Ex. | 3.72 | 99.0 | 155 | B | B | A | B | B |
| No. 7 | Ex. | 3.81 | 99.1 | 157 | B | B | A | B | B |
| No. 8 | Ex. | 3.75 | 98.5 | 150 | B | B | A | B | B |
| No. 9 | Ex. | 3.79 | 98.2 | 151 | B | B | B | B | B |
| No. 10 | Comp. Ex. | 3.74 | 96.5 | 129 | D | D | B | D | D |
| No. 11 | Comp. Ex. | 3.89 | 96.7 | 135 | D | D | B | D | D |
| No. 12 | Comp. Ex. | 3.66 | 96.3 | 125 | E | E | C | E | E |
| No. 13 | Comp. Ex. | 4.89 | 94.8 | 117 | D | D | D | D | D |
| No. 14 | Comp. Ex. | 4.31 | 94.8 | 119 | D | D | E | D | D |
| No. 15 | Comp. Ex. | 3.66 | 94.7 | 105 | E | E | C | E | E |
| No. 16 | Comp. Ex. | 3.53 | 93.1 | 136 | F | F | E | F | F |
| No. 17 | Comp. Ex. | 4.78 | 95.8 | 120 | D | D | B | D | D |
| No. 18 | Comp. Ex. | 4.56 | 93.5 | 139 | E | E | F | E | E |
| No. 19 | Comp. Ex. | 3.87 | 99.3 | 178 | A | A | B | A | B |

TABLE 4

| | | Metal | | | | | | | |
|---|---|---|---|---|---|---|---|---|---|
| | | powder | Evaluation results of sintered body | | | | | | |
| | | Average | | | | 0.2% | | | |
| | | particle | Relative | Vickers | Tensile | proof | | Fatigue | Aesthetic |
| Sample | | diameter | density | hardness | strength | stress | Elongation | strength | appearance |
| No. | — | μm | % | — | — | — | — | — | — |
| No. 20 | Ex. | 4.07 | 99.5 | 167 | A | A | A | A | A |
| No. 21 | Ex. | 3.82 | 99.4 | 176 | A | A | A | A | A |
| No. 22 | Ex. | 3.78 | 99.3 | 171 | A | A | A | A | A |
| No. 23 | Ex. | 3.83 | 98.8 | 154 | B | A | A | A | A |
| No. 24 | Ex. | 4.58 | 99.6 | 182 | A | A | A | A | A |
| No. 25 | Ex. | 3.66 | 98.8 | 156 | B | B | A | B | B |
| No. 26 | Ex. | 3.75 | 98.9 | 160 | B | B | A | B | B |
| No. 27 | Ex. | 3.79 | 98.4 | 156 | B | B | A | B | B |
| No. 28 | Ex. | 3.82 | 98.3 | 154 | B | B | B | B | B |
| No. 29 | Comp. Ex. | 3.76 | 96.5 | 128 | D | D | B | D | D |
| No. 30 | Comp. Ex. | 3.92 | 96.8 | 135 | D | D | B | D | D |
| No. 31 | Comp. Ex. | 3.56 | 96.3 | 128 | E | E | C | E | E |
| No. 32 | Comp. Ex. | 4.77 | 94.8 | 120 | D | D | D | D | D |
| No. 33 | Comp. Ex. | 4.21 | 94.7 | 124 | D | D | E | D | D |
| No. 34 | Comp. Ex. | 3.76 | 99.2 | 178 | A | A | B | A | B |

As apparent from Tables 3 and 4, it was confirmed that the sintered bodies corresponding to Example each have a higher relative density than the sintered bodies corresponding to Comparative Example (excluding the sintered bodies having undergone the HIP treatment). Further, it was also confirmed that there is a significant difference in properties such as tensile strength, 0.2% proof stress, and elongation between the sintered bodies corresponding to Example and the sintered bodies corresponding to Comparative Example (excluding the sintered bodies having undergone the HIP treatment) . It was also confirmed that the sintered bodies corresponding to Example each have high specularity and therefore have excellent aesthetic appearance.

On the other hand, by comparison of the respective physical property values between the sintered bodies corresponding to Example and the sintered bodies having undergone the HIP treatment, it was confirmed that the physical property values are all comparable to each other.

### 2.6 Observation of Cross Section of Sintered Body Using Scanning Electron Microscope (SEM)

An observation image was obtained for the cross section of each sintered body using a scanning electron microscope (JXA-8500F, manufactured by JEOL Ltd.). When the image was taken, the acceleration voltage was set to 10 kV, and the magnification was set to 300 times.

As a result of observation, a region in which Fe is contained as a major component (first region D1) and a region in which O is contained as a major component and Si is contained as a second major component (second region D2) were present in the cross section of the surface layer of each sintered body. Here, the area ratio of the first region D1 in the cross section of the surface layer is represented by P1, and the area ratio of the second region D2 in the cross section of the surface layer is represented by P2. The shade difference on the microscopic observation image was clear, and therefore, the first region D1 and the second region D2 could be easily distinguished from each other. Further, the first region D1 occupied the largest area, and the second region D2 occupies the second largest area.

Incidentally, in each sintered body, the area ratio P1 was 95% or more.

Further, in a qualitative and quantitative analysis for each region, an electron probe microanalyzer was used. Then, P2/(P1+P2) calculated from the area ratio of each region is shown in Tables 1 and 2.

### 3. Production of Sintered Body (Hf—Nb Based) Sample Nos. 35 to 48

Sintered bodies were obtained in the same manner as the method for producing the sintered body of sample No. 1 except that the composition and the like of the metal powder for powder metallurgy were changed as shown in Table 5, respectively.

TABLE 5

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Hf) | (Nb) | Mo | Mn | O | Fe |
| No. | — | mass % | | | | | | | | | |
| No. 35 | Ex. | 16.23 | 12.54 | 0.70 | 0.03 | 0.09 | 0.05 | 2.11 | 0.05 | 0.26 | remainder |
| No. 36 | Ex. | 17.16 | 12.51 | 0.56 | 0.03 | 0.07 | 0.05 | 2.43 | 0.10 | 0.31 | remainder |
| No. 37 | Ex. | 17.80 | 13.23 | 0.54 | 0.03 | 0.08 | 0.09 | 2.05 | 0.09 | 0.42 | remainder |
| No. 38 | Ex. | 16.27 | 14.70 | 0.79 | 0.01 | 0.06 | 0.03 | 2.87 | 0.08 | 0.26 | remainder |
| No. 39 | Ex. | 17.54 | 13.88 | 0.75 | 0.03 | 0.09 | 0.11 | 2.65 | 0.12 | 0.35 | remainder |
| No. 40 | Ex. | 16.84 | 12.50 | 0.54 | 0.08 | 0.11 | 0.04 | 2.78 | 0.10 | 0.22 | remainder |
| No. 41 | Ex. | 17.50 | 13.23 | 0.67 | 0.05 | 0.07 | 0.12 | 2.18 | 0.77 | 0.39 | remainder |
| No. 42 | Comp. | 16.32 | 12.82 | 0.74 | 0.03 | 0.00 | 0.07 | 2.35 | 0.12 | 0.28 | remainder |
| | Ex. | | | | | | | | | | |
| No. 43 | Comp. | 17.24 | 13.33 | 0.83 | 0.03 | 0.08 | 0.00 | 2.25 | 0.09 | 0.33 | remainder |
| | Ex. | | | | | | | | | | |
| No. 44 | Comp. | 16.72 | 14.21 | 0.73 | 0.02 | 0.00 | 0.00 | 2.35 | 0.13 | 0.35 | remainder |
| | Ex. | | | | | | | | | | |
| No. 45 | Comp. | 17.33 | 12.56 | 0.88 | 0.02 | 0.72 | 0.05 | 2.58 | 0.12 | 0.37 | remainder |
| | Ex. | | | | | | | | | | |
| No. 46 | Comp. | 16.45 | 13.13 | 0.66 | 0.03 | 0.04 | 0.68 | 2.42 | 0.07 | 0.43 | remainder |
| | Ex. | | | | | | | | | | |
| No. 47 | Comp. | 16.65 | 13.23 | 0.15 | 0.01 | 0.06 | 0.07 | 2.78 | 0.13 | 0.28 | remainder |
| | Ex. | | | | | | | | | | |
| No. 48 | Comp. | 16.55 | 13.31 | 1.89 | 0.05 | 0.07 | 0.05 | 2.66 | 0.35 | 0.47 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 35 | 1.80 | 0.14 | 0.20 | 4.67 | Pre-mix | 0.03 | 3.02 | 2.99 | |
| | | No. 36 | 1.40 | 0.12 | 0.21 | 4.00 | Pre-mix | 0.04 | 3.05 | 3.01 | |
| | | No. 37 | 0.89 | 0.17 | 0.31 | 6.30 | Pre-mix | 0.05 | 3.12 | 3.07 | |
| | | No. 38 | 2.00 | 0.09 | 0.11 | 7.50 | Pre-mix | 0.07 | 3.42 | 3.35 | |
| | | No. 39 | 0.82 | 0.20 | 0.27 | 7.69 | Pre-mix | 0.08 | 3.33 | 3.25 | |
| | | No. 40 | 2.75 | 0.15 | 0.28 | 1.88 | Pre-mix | 0.12 | 4.68 | 4.56 | |
| | | No. 41 | 0.58 | 0.19 | 0.28 | 3.80 | Pre-mix | 0.15 | 4.79 | 4.64 | |
| | | No. 42 | 0.00 | 0.07 | 0.09 | 2.80 | Pre-mix | 4.81 | 5.21 | 0.40 | |
| | | No. 43 | — | 0.08 | 0.10 | 2.86 | Pre-mix | 1.12 | 4.56 | 3.44 | |
| | | No. 44 | — | 0.00 | 0.00 | 0.00 | Pre-mix | 5.92 | 6.21 | 0.29 | |
| | | No. 45 | 14.40 | 0.77 | 0.88 | 36.67 | Pre-mix | 0.61 | 4.11 | 3.50 | |
| | | No. 46 | 0.06 | 0.72 | 1.09 | 21.18 | Pre-mix | 3.60 | 4.98 | 1.38 | |
| | | No. 47 | 0.86 | 0.13 | 0.87 | 10.83 | Pre-mix | 2.80 | 4.56 | 1.76 | |
| | | No. 48 | 1.40 | 0.12 | 0.06 | 2.22 | Pre-mix | 4.50 | 5.02 | 0.52 | |

In Table 5, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 5.

### Sample Nos. 49 to 55

Sintered bodies were obtained in the same manner as the method for producing the sintered body of sample No. 20 except that the composition and the like of the metal powder for powder metallurgy were changed as shown in Table 6, respectively.

TABLE 6

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Hf) | (Nb) | Mo | Mn | O | Fe |
| No. | — | mass % | | | | | | | | | |
| No. 49 | Ex. | 18.91 | 13.52 | 0.81 | 0.042 | 0.09 | 0.05 | 3.55 | 0.36 | 0.42 | remainder |
| No. 50 | Ex. | 18.26 | 14.85 | 0.55 | 0.022 | 0.07 | 0.09 | 3.12 | 0.88 | 0.41 | remainder |
| No. 51 | Ex. | 19.75 | 11.33 | 0.34 | 0.068 | 0.09 | 0.10 | 3.85 | 0.46 | 0.56 | remainder |
| No. 52 | Comp. | 18.65 | 11.34 | 0.77 | 0.052 | 0.00 | 0.07 | 3.45 | 0.23 | 0.28 | remainder |
| | Ex. | | | | | | | | | | |
| No. 53 | Comp. | 19.52 | 14.32 | 0.88 | 0.021 | 0.11 | 0.00 | 3.54 | 0.08 | 0.30 | remainder |
| | Ex. | | | | | | | | | | |
| No. 54 | Comp. | 18.67 | 11.84 | 0.69 | 0.025 | 0.53 | 0.07 | 3.75 | 0.11 | 0.37 | remainder |
| | Ex. | | | | | | | | | | |
| No. 55 | Comp. | 19.45 | 14.54 | 0.59 | 0.025 | 0.07 | 0.66 | 3.56 | 0.08 | 0.42 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 49 | 1.80 | 0.14 | 0.17 | 3.33 | Pre-alloy | 0.07 | 3.18 | 3.11 | |
| | | No. 50 | 0.78 | 0.16 | 0.29 | 7.27 | Pre-alloy | 0.06 | 3.12 | 3.06 | |
| | | No. 51 | 0.90 | 0.19 | 0.56 | 2.79 | Pre-alloy | 0.08 | 3.23 | 3.15 | |
| | | No. 52 | 0.00 | 0.07 | 0.09 | 1.35 | Pre-alloy | 4.51 | 5.16 | 0.65 | |
| | | No. 53 | — | 0.11 | 0.13 | 5.24 | Pre-alloy | 1.53 | 4.89 | 3.36 | |
| | | No. 54 | 7.57 | 0.60 | 0.87 | 24.00 | Pre-alloy | 2.12 | 4.32 | 2.20 | |
| | | No. 55 | 0.11 | 0.73 | 1.24 | 29.20 | Pre-alloy | 2.89 | 4.68 | 1.79 | |

In Table 6, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 6.

### 4. Evaluation of Sintered Body (Hf—Nb Based)

### 4.1 Evaluation of Relative Density

With respect to the sintered bodies of the respective sample Nos. shown in Tables 5 and 6, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Tables 7 and 8.

### 4.2 Evaluation of Vickers Hardness

With respect to the sintered bodies of the respective sample Nos. shown in Tables 5 and 6, the Vickers hardness was measured in accordance with the Vickers hardness test method specified in JIS Z 2244 (2009).

The measurement results are shown in Tables 7 and 8.

### 4.3 Evaluation of Tensile Strength, 0.2% Proof Stress, and Elongation

With respect to the sintered bodies of the respective sample Nos. shown in Tables 5 and 6, the tensile strength, 0.2% proof stress, and elongation were measured in accordance with the metal material tensile test method specified in JIS Z 2241 (2011).

Then, the measured physical property values of the sintered bodies of the respective sample Nos. shown in Tables 5 and 6 were evaluated according to the evaluation criteria applied to Tables 3 and 4 described above.

The above evaluation results are shown in Tables 7 and 8.

### 4.4 Evaluation of Aesthetic Appearance

With respect to the sintered bodies of the respective sample Nos. shown in Tables 5 and 6, polishing was performed and also the specular glossiness was measured and evaluated in the same manner as in the above-mentioned 2.5.

The above evaluation results are shown in Tables 7 and 8.

### 4.5 Observation of Cross Section of Sintered Body Using Scanning Electron Microscope (SEM)

An observation image was obtained for the cross section of each sintered body using a scanning electron microscope in the same manner as in the case of the sintered body of sample No. 1. Then, P2/(P1+P2) was calculated. The calculation results are shown in Tables 5 and 6.

TABLE 7

| | | Metal | | | | | | |
|---|---|---|---|---|---|---|---|---|
| | | powder | Evaluation results of sintered body | | | | | |
| | | Average | | | | 0.2% | | |
| | | particle | Relative | Vickers | Tensile | proof | | Aesthetic |
| Sample | | diameter | density | hardness | strength | stress | Elongation | appearance |
| No. | — | μm | % | — | — | — | — | — |
| No. 35 | Ex. | 4.15 | 99.6 | 164 | A | A | A | A |
| No. 36 | Ex. | 4.23 | 99.4 | 175 | A | A | A | A |
| No. 37 | Ex. | 4.05 | 98.8 | 162 | A | A | A | A |
| No. 38 | Ex. | 3.92 | 98.6 | 155 | B | A | A | B |
| No. 39 | Ex. | 4.58 | 99.0 | 176 | A | A | A | B |
| No. 40 | Ex. | 4.02 | 99.3 | 172 | A | A | A | B |
| No. 41 | Ex. | 3.79 | 98.4 | 186 | B | B | B | B |
| No. 42 | Comp. Ex. | 3.87 | 96.5 | 187 | D | D | B | D |
| No. 43 | Comp. Ex. | 4.01 | 96.9 | 182 | D | D | B | D |
| No. 44 | Comp. Ex. | 4.03 | 96.3 | 193 | E | E | C | E |
| No. 45 | Comp. Ex. | 4.58 | 94.8 | 204 | D | D | D | D |
| No. 46 | Comp. Ex. | 4.56 | 94.8 | 213 | D | D | E | D |
| No. 47 | Comp. Ex. | 3.66 | 94.7 | 196 | E | E | D | E |
| No. 48 | Comp. Ex. | 3.26 | 93.5 | 215 | F | F | E | F |

TABLE 8

| | | Metal | | | | | | |
|---|---|---|---|---|---|---|---|---|
| | | powder | Evaluation results of sintered body | | | | | |
| | | Average | | | | 0.2% | | |
| | | particle | Relative | Vickers | Tensile | proof | | Aesthetic |
| Sample | | diameter | density | hardness | strength | stress | Elongation | appearance |
| No. | — | μm | % | — | — | — | — | — |
| No. 49 | Ex. | 5.87 | 99.0 | 165 | A | A | A | A |
| No. 50 | Ex. | 4.98 | 98.8 | 169 | A | A | A | A |
| No. 51 | Ex. | 4.31 | 98.5 | 182 | B | B | B | B |
| No. 52 | Comp. Ex. | 5.32 | 96.4 | 194 | D | D | B | D |
| No. 53 | Comp. Ex. | 5.84 | 96.7 | 188 | D | D | B | D |
| No. 54 | Comp. Ex. | 4.53 | 95.2 | 200 | D | D | D | D |
| No. 55 | Comp. Ex. | 4.18 | 95.0 | 203 | E | E | F | E |

As apparent from Tables 7 and 8, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example. It was also confirmed that the sintered bodies corresponding to Example each have high specularity and therefore have excellent aesthetic appearance.

### 5. Production of Sintered Body (Ti—Nb Based)

### Sample Nos. 56 to 65

Sintered bodies were obtained in the same manner as the method for producing the sintered body of sample No. 1 except that the composition and the like of the metal powder for powder metallurgy were changed as shown in Table 9, respectively.

TABLE 9

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Ti) | (Nb) | Mo | Mn | O | Fe |
| No. | — | mass % | | | | | | | | | |
| No. 56 | Ex. | 16.50 | 12.52 | 0.75 | 0.016 | 0.08 | 0.08 | 2.12 | 0.06 | 0.26 | remainder |
| No. 57 | Ex. | 16.85 | 13.13 | 0.52 | 0.022 | 0.08 | 0.07 | 2.21 | 0.52 | 0.43 | remainder |
| No. 58 | Ex. | 16.65 | 11.85 | 0.80 | 0.024 | 0.06 | 0.10 | 2.05 | 0.34 | 0.24 | remainder |
| No. 59 | Ex. | 17.10 | 12.59 | 0.97 | 0.066 | 0.04 | 0.18 | 2.25 | 0.08 | 0.55 | remainder |
| No. 60 | Ex. | 16.21 | 13.55 | 0.53 | 0.008 | 0.04 | 0.08 | 2.25 | 0.02 | 0.36 | remainder |
| No. 61 | Ex. | 17.87 | 12.35 | 0.43 | 0.125 | 0.09 | 0.08 | 2.58 | 0.36 | 0.26 | remainder |
| No. 62 | Comp. | 16.88 | 11.43 | 0.57 | 0.054 | 0.00 | 0.08 | 2.48 | 0.13 | 0.26 | remainder |
| | Ex. | | | | | | | | | | |
| No. 63 | Comp. | 17.55 | 14.50 | 0.75 | 0.030 | 0.12 | 0.00 | 2.67 | 0.10 | 0.30 | remainder |
| | Ex. | | | | | | | | | | |
| No. 64 | Comp. | 16.75 | 11.21 | 0.86 | 0.011 | 0.54 | 0.06 | 2.54 | 0.14 | 0.30 | remainder |
| | Ex. | | | | | | | | | | |
| No. 65 | Comp. | 17.64 | 14.14 | 0.67 | 0.052 | 0.08 | 0.89 | 2.62 | 0.05 | 0.24 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 56 | 1.00 | 0.16 | 0.21 | 10.00 | Pre-mix | 0.04 | 3.25 | 3.21 | |
| | | No. 57 | 1.14 | 0.15 | 0.29 | 6.82 | Pre-mix | 0.08 | 3.54 | 3.46 | |
| | | No. 58 | 0.60 | 0.16 | 0.20 | 6.67 | Pre-mix | 0.10 | 3.69 | 3.59 | |
| | | No. 59 | 0.22 | 0.22 | 0.23 | 3.33 | Pre-mix | 0.24 | 5.58 | 5.34 | |
| | | No. 60 | 0.50 | 0.12 | 0.23 | 15.00 | Pre-mix | 0.20 | 5.42 | 5.22 | |
| | | No. 61 | 1.13 | 0.17 | 0.40 | 1.36 | Pre-mix | 0.26 | 6.21 | 5.95 | |
| | | No. 62 | 0.00 | 0.08 | 0.14 | 1.48 | Pre-mix | 4.82 | 6.80 | 1.98 | |
| | | No. 63 | — | 0.12 | 0.16 | 4.00 | Pre-mix | 1.51 | 5.56 | 4.05 | |
| | | No. 64 | 9.00 | 0.60 | 0.70 | 54.55 | Pre-mix | 0.52 | 5.32 | 4.80 | |
| | | No. 65 | 0.09 | 0.97 | 1.45 | 18.65 | Pre-mix | 1.82 | 5.69 | 3.87 | |

In Table 9, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 9.

### 6. Evaluation of Sintered Body (Ti—Nb Based)

### 6.1 Evaluation of Relative Density

With respect to the sintered bodies of the respective sample Nos. shown in Table 9, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 10.

### 6.2 Evaluation of Vickers Hardness

With respect to the sintered bodies of the respective sample Nos . shown in Table 9, the Vickers hardness was measured in accordance with the Vickers hardness test method specified in JIS Z 2244 (2009).

The measurement results are shown in Table 10.

### 6.3 Evaluation of Tensile Strength, 0.2% Proof Stress, and Elongation

With respect to the sintered bodies of the respective sample Nos. shown in Table 9, the tensile strength, 0.2% proof stress, and elongation were measured in accordance with the metal material tensile test method specified in JIS Z 2241 (2011).

Then, these measured physical property values were evaluated according to the evaluation criteria applied to Tables 3 and 4 described above.

The above evaluation results are shown in Table 10.

### 6.4 Evaluation of Aesthetic Appearance

With respect to the sintered bodies of the respective sample Nos. shown in Table 9, polishing was performed and also the specular glossiness was measured and evaluated in the same manner as in the above-mentioned 2.5.

The above evaluation results are shown in Table 10.

### 6.5 Observation of Cross Section of Sintered Body Using Scanning Electron Microscope (SEM)

An observation image was obtained for the cross section of each sintered body using a scanning electron microscope in the same manner as in the case of the sintered body of sample No. 1. Then, P2/(P1+P2) was calculated. The calculation results are shown in Table 9.

TABLE 10

| | | Metal | | | | | | |
|---|---|---|---|---|---|---|---|---|
| | | powder | Evaluation results of sintered body | | | | | |
| | | Average | | | | 0.2% | | |
| | | particle | Relative | Vickers | Tensile | proof | | Aesthetic |
| Sample | | diameter | density | hardness | strength | stress | Elongation | appearance |
| No. | — | μm | % | — | — | — | — | — |
| No. 56 | Ex. | 4.35 | 99.0 | 181 | A | A | A | A |
| No. 57 | Ex. | 4.82 | 99.4 | 179 | A | A | A | A |
| No. 58 | Ex. | 4.08 | 99.5 | 177 | A | A | A | A |
| No. 59 | Ex. | 3.92 | 98.8 | 182 | B | B | A | B |
| No. 60 | Ex. | 4.15 | 98.6 | 186 | B | B | B | B |
| No. 61 | Ex. | 4.25 | 98.3 | 191 | B | B | C | B |
| No. 62 | Comp. Ex. | 4.32 | 96.7 | 192 | D | D | B | D |
| No. 63 | Comp. Ex. | 4.49 | 96.8 | 190 | D | D | B | D |
| No. 64 | Comp. Ex. | 4.26 | 95.5 | 206 | D | D | D | D |
| No. 65 | Comp. Ex. | 4.41 | 94.9 | 217 | E | E | F | E |

As apparent from Table 10, it was confirmed that the sintered bodies corresponding to Example each have a higher relative density than the sintered bodies corresponding to Comparative Example. It was also confirmed that there is a significant difference in properties such as tensile strength, 0.2%proof stress, and elongation between the sintered bodies corresponding to Example and the sintered bodies corresponding to Comparative Example. It was also confirmed that the sintered bodies corresponding to Example each have high specularity and therefore have excellent aesthetic appearance.

### 7. Production of Sintered Body (Nb—Ta Based)

### Sample Nos. 66 to 75

Sintered bodies were obtained in the same manner as the method for producing the sintered body of sample No. 1 except that the composition and the like of the metal powder for powder metallurgy were changed as shown in Table 11, respectively.

TABLE 11

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Nb) | (Ta) | Mo | Mn | O | Fe |
| No. | — | mass % | | | | | | | | | |
| No. 66 | Ex. | 16.23 | 12.16 | 0.65 | 0.034 | 0.08 | 0.12 | 2.23 | 0.07 | 0.39 | remainder |
| No. 67 | Ex. | 16.72 | 11.35 | 0.86 | 0.040 | 0.05 | 0.10 | 2.24 | 0.04 | 0.43 | remainder |
| No. 68 | Ex. | 16.29 | 10.23 | 0.46 | 0.019 | 0.12 | 0.09 | 2.69 | 0.09 | 0.59 | remainder |
| No. 69 | Ex. | 16.34 | 13.65 | 1.02 | 0.068 | 0.05 | 0.08 | 2.78 | 0.07 | 0.23 | remainder |
| No. 70 | Ex. | 16.43 | 14.16 | 0.87 | 0.009 | 0.03 | 0.04 | 2.47 | 0.00 | 0.44 | remainder |
| No. 71 | Ex. | 16.23 | 12.33 | 0.46 | 0.119 | 0.15 | 0.09 | 2.17 | 0.09 | 0.49 | remainder |
| No. 72 | Comp. | 17.13 | 12.31 | 0.75 | 0.063 | 0.00 | 0.05 | 2.15 | 0.16 | 0.28 | remainder |
| | Ex. | | | | | | | | | | |
| No. 73 | Comp. | 16.77 | 12.45 | 0.78 | 0.022 | 0.08 | 0.00 | 2.05 | 0.11 | 0.32 | remainder |
| | Ex. | | | | | | | | | | |
| No. 74 | Comp. | 16.45 | 13.66 | 0.39 | 0.013 | 0.69 | 0.07 | 2.88 | 0.09 | 0.36 | remainder |
| | Ex. | | | | | | | | | | |
| No. 75 | Comp. | 17.23 | 10.87 | 0.42 | 0.021 | 0.07 | 0.61 | 3.02 | 0.15 | 0.36 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 66 | 0.67 | 0.20 | 0.31 | 5.88 | Pre-mix | 0.12 | 3.24 | 3.12 | |
| | | No. 67 | 0.50 | 0.15 | 0.17 | 3.75 | Pre-mix | 0.16 | 3.32 | 3.16 | |
| | | No. 68 | 1.33 | 0.21 | 0.46 | 11.05 | Pre-mix | 0.22 | 4.44 | 4.22 | |
| | | No. 69 | 0.63 | 0.13 | 0.13 | 1.91 | Pre-mix | 0.28 | 4.46 | 4.18 | |
| | | No. 70 | 0.75 | 0.07 | 0.08 | 7.78 | Pre-mix | 0.26 | 4.52 | 4.26 | |
| | | No. 71 | 1.67 | 0.24 | 0.52 | 2.02 | Pre-mix | 0.29 | 4.58 | 4.29 | |
| | | No. 72 | 0.00 | 0.05 | 0.07 | 0.79 | Pre-mix | 4.21 | 7.22 | 3.01 | |
| | | No. 73 | — | 0.08 | 0.10 | 3.64 | Pre-mix | 0.82 | 3.74 | 2.92 | |
| | | No. 74 | 9.86 | 0.76 | 0.95 | 58.46 | Pre-mix | 0.93 | 2.91 | 1.98 | |
| | | No. 75 | 0.11 | 0.68 | 1.62 | 32.38 | Pre-mix | 2.25 | 4.21 | 1.96 | |

In Table 11, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 11.

### 8. Evaluation of Sintered Body (Nb—Ta Based)

### 8.1 Evaluation of Relative Density

With respect to the sintered bodies of the respective sample Nos. shown in Table 11, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 12.

### 8.2 Evaluation of Vickers Hardness

With respect to the sintered bodies of the respective sample Nos . shown in Table 11, the Vickers hardness was measured in accordance with the Vickers hardness test method specified in JIS Z 2244 (2009).

The measurement results are shown in Table 12.

### 8.3 Evaluation of Tensile Strength, 0.2% Proof Stress, and Elongation

With respect to the sintered bodies of the respective sample Nos. shown in Table 11, the tensile strength, 0.2%proof stress, and elongation were measured in accordance with the metal material tensile test method specified in JIS Z 2241 (2011).

Then, these measured physical property values were evaluated according to the evaluation criteria applied to Tables 3 and 4 described above.

The above evaluation results are shown in Table 12.

### 8.4 Evaluation of Aesthetic Appearance

With respect to the sintered bodies of the respective sample Nos. shown in Table 11, polishing was performed and also the specular glossiness was measured and evaluated in the same manner as in the above-mentioned 2.5.

The above evaluation results are shown in Table 12.

### 8.5 Observation of Cross Section of Sintered Body Using Scanning Electron Microscope (SEM)

An observation image was obtained for the cross section of each sintered body using a scanning electron microscope in the same manner as in the case of the sintered body of sample No. 1. Then, P2/(P1+P2) was calculated. The calculation results are shown in Table 11.

TABLE 12

| | | Metal | | | | | | |
|---|---|---|---|---|---|---|---|---|
| | | powder | Evaluation results of sintered body | | | | | |
| | | Average | | | | 0.2% | | |
| | | particle | Relative | Vickers | Tensile | proof | | Aesthetic |
| Sample | | diameter | density | hardness | strength | stress | Elongation | appearance |
| No. | — | μm | % | — | — | — | — | — |
| No. 66 | Ex. | 3.87 | 99.0 | 166 | A | A | A | A |
| No. 67 | Ex. | 4.12 | 99.1 | 167 | A | A | B | A |
| No. 68 | Ex. | 6.45 | 98.5 | 173 | A | A | B | A |
| No. 69 | Ex. | 5.82 | 98.3 | 178 | B | B | B | B |
| No. 70 | Ex. | 3.45 | 98.2 | 175 | B | B | B | B |
| No. 71 | Ex. | 3.25 | 97.4 | 181 | B | B | C | B |
| No. 72 | Comp. Ex. | 3.98 | 96.3 | 187 | D | D | B | D |
| No. 73 | Comp. Ex. | 3.74 | 96.0 | 198 | D | D | B | D |
| No. 74 | Comp. Ex. | 4.21 | 93.8 | 236 | D | D | D | D |
| No. 75 | Comp. Ex. | 3.87 | 94.2 | 225 | D | D | E | D |

As apparent from Table 12, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example. It was also confirmed that the sintered bodies corresponding to Example each have high specularity and therefore have excellent aesthetic appearance.

### 9. Production of Sintered Body (Y—Nb Based)

### Sample Nos. 76 to 86

Sintered bodies were obtained in the same manner as the method for producing the sintered body of sample No. 1 except that the composition and the like of the metal powder for powder metallurgy were changed as shown in Table 13, respectively.

TABLE 13

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (Y) | (Nb) | Mo | Mn | O | Fe |
| No. | — | mass % | | | | | | | | | |
| No. 76 | Ex. | 16.54 | 12.56 | 0.86 | 0.026 | 0.08 | 0.09 | 2.16 | 0.06 | 0.26 | remainder |
| No. 77 | Ex. | 17.34 | 12.85 | 0.66 | 0.024 | 0.05 | 0.08 | 2.23 | 0.12 | 0.34 | remainder |
| No. 78 | Ex. | 16.34 | 12.31 | 0.75 | 0.028 | 0.09 | 0.06 | 2.03 | 0.09 | 0.39 | remainder |
| No. 79 | Ex. | 16.33 | 14.53 | 0.54 | 0.012 | 0.03 | 0.09 | 2.69 | 0.08 | 0.27 | remainder |
| No. 80 | Ex. | 17.10 | 13.85 | 0.56 | 0.021 | 0.09 | 0.10 | 2.53 | 0.14 | 0.36 | remainder |
| No. 81 | Ex. | 16.64 | 11.55 | 0.99 | 0.054 | 0.10 | 0.04 | 2.75 | 0.13 | 0.25 | remainder |
| No. 82 | Ex. | 16.18 | 13.23 | 0.33 | 0.045 | 0.09 | 0.12 | 2.10 | 0.81 | 0.42 | remainder |
| No. 83 | Comp. | 16.53 | 12.72 | 0.82 | 0.025 | 0.00 | 0.06 | 2.23 | 0.12 | 0.29 | remainder |
| | Ex. | | | | | | | | | | |
| No. 84 | Comp. | 17.23 | 12.75 | 0.72 | 0.021 | 0.07 | 0.00 | 2.19 | 0.07 | 0.28 | remainder |
| | Ex. | | | | | | | | | | |
| No. 85 | Comp. | 16.88 | 12.35 | 0.88 | 0.029 | 0.62 | 0.12 | 2.66 | 0.23 | 0.42 | remainder |
| | Ex. | | | | | | | | | | |
| No. 86 | Comp. | 16.41 | 13.12 | 0.72 | 0.034 | 0.08 | 0.72 | 2.32 | 0.06 | 0.38 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 76 | 0.89 | 0.17 | 0.20 | 6.54 | Pre-mix | 0.07 | 3.26 | 3.19 | |
| | | No. 77 | 0.63 | 0.13 | 0.20 | 5.42 | Pre-mix | 0.11 | 3.41 | 3.30 | |
| | | No. 78 | 1.50 | 0.15 | 0.20 | 5.36 | Pre-mix | 0.17 | 3.69 | 3.52 | |
| | | No. 79 | 0.33 | 0.12 | 0.22 | 10.00 | Pre-mix | 0.25 | 4.87 | 4.62 | |
| | | No. 80 | 0.90 | 0.19 | 0.34 | 9.05 | Pre-mix | 0.22 | 4.74 | 4.52 | |
| | | No. 81 | 2.50 | 0.14 | 0.14 | 2.59 | Pre-mix | 0.29 | 5.12 | 4.83 | |
| | | No. 82 | 0.75 | 0.21 | 0.64 | 4.67 | Pre-mix | 0.28 | 5.08 | 4.80 | |
| | | No. 83 | 0.00 | 0.06 | 0.07 | 2.40 | Pre-mix | 3.82 | 5.80 | 1.98 | |
| | | No. 84 | — | 0.07 | 0.10 | 3.33 | Pre-mix | 1.25 | 5.22 | 3.97 | |
| | | No. 85 | 5.17 | 0.74 | 0.84 | 25.52 | Pre-mix | 0.54 | 4.69 | 4.15 | |
| | | No. 86 | 0.11 | 0.80 | 1.11 | 23.53 | Pre-mix | 1.63 | 5.39 | 3.76 | |

In Table 13, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 13.

### 10. Evaluation of Sintered Body (Y—Nb Based)

### 10.1 Evaluation of Relative Density

With respect to the sintered bodies of the respective sample Nos. shown in Table 13, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 14.

### 10.2 Evaluation of Vickers Hardness

With respect to the sintered bodies of the respective sample Nos . shown in Table 13, the Vickers hardness was measured in accordance with the Vickers hardness test method specified in JIS Z 2244 (2009).

The measurement results are shown in Table 14.

### 10.3 Evaluation of Tensile Strength, 0.2% Proof Stress, and Elongation

With respect to the sintered bodies of the respective sample Nos. shown in Table 13, the tensile strength, 0.2%proof stress, and elongation were measured in accordance with the metal material tensile test method specified in JIS Z 2241 (2011).

Then, these measured physical property values were evaluated according to the evaluation criteria applied to Tables 3 and 4 described above.

The above evaluation results are shown in Table 14.

### 10.4 Evaluation of Aesthetic Appearance

With respect to the sintered bodies of the respective sample Nos. shown in Table 13, polishing was performed and also the specular glossiness was measured and evaluated in the same manner as in the above-mentioned 2.5.

The above evaluation results are shown in Table 14.

### 10.5 Observation of Cross Section of Sintered Body Using Scanning Electron Microscope (SEM)

An observation image was obtained for the cross section of each sintered body using a scanning electron microscope in the same manner as in the case of the sintered body of sample No. 1. Then, P2/(P1+P2) was calculated. The calculation results are shown in Table 13.

TABLE 14

| | | Metal | | | | | | |
|---|---|---|---|---|---|---|---|---|
| | | powder | Evaluation results of sintered body | | | | | |
| | | Average | | | | 0.2% | | |
| | | particle | Relative | Vickers | Tensile | proof | | Aesthetic |
| Sample | | diameter | density | hardness | strength | stress | Elongation | appearance |
| No. | — | μm | % | — | — | — | — | — |
| No. 76 | Ex. | 4.08 | 99.3 | 171 | A | A | A | A |
| No. 77 | Ex. | 3.87 | 99.2 | 172 | A | A | A | A |
| No. 78 | Ex. | 3.92 | 99.1 | 173 | A | A | A | A |
| No. 79 | Ex. | 4.21 | 98.8 | 178 | B | A | A | A |
| No. 80 | Ex. | 4.15 | 99.3 | 175 | A | A | A | A |
| No. 81 | Ex. | 3.89 | 98.6 | 182 | B | B | B | B |
| No. 82 | Ex. | 3.71 | 98.5 | 183 | B | B | B | B |
| No. 83 | Comp. Ex. | 3.78 | 96.2 | 193 | D | D | B | D |
| No. 84 | Comp. Ex. | 4.02 | 96.0 | 197 | D | D | B | D |
| No. 85 | Comp. Ex. | 4.79 | 95.0 | 205 | D | E | E | E |
| No. 86 | Comp. Ex. | 4.61 | 94.7 | 206 | D | E | E | E |

As apparent from Table 14, it was confirmed that the sintered bodies corresponding to Example each have a higher relative density than the sintered bodies corresponding to Comparative Example. It was also confirmed that there is a significant difference in properties such as tensile strength, 0.2%proof stress, and elongation between the sintered bodies corresponding to Example and the sintered bodies corresponding to Comparative Example. It was also confirmed that the sintered bodies corresponding to Example each have high specularity and therefore have excellent aesthetic appearance.

### 11. Production of Sintered Body (V—Nb Based)

### Sample Nos. 87 to 96

Sintered bodies were obtained in the same manner as the method for producing the sintered body of sample No. 1 except that the composition and the like of the metal powder for powder metallurgy were changed as shown in Table 15, respectively.

TABLE 15

| | | Metal powder for powder metallurgy | | | | | | | | | |
|---|---|---|---|---|---|---|---|---|---|---|---|
| | | Alloy composition | | | | | | | | | |
| | | | | | | E1 | E2 | | | | |
| Sample | | Cr | Ni | Si | C | (V) | (Nb) | Mo | Mn | O | Fe |
| No. | — | mass % | | | | | | | | | |
| No. 87 | Ex. | 16.54 | 12.64 | 0.78 | 0.024 | 0.07 | 0.14 | 2.33 | 0.05 | 0.25 | remainder |
| No. 88 | Ex. | 16.43 | 12.37 | 0.72 | 0.017 | 0.05 | 0.10 | 2.29 | 0.09 | 0.32 | remainder |
| No. 89 | Ex. | 17.25 | 12.16 | 0.90 | 0.023 | 0.15 | 0.12 | 2.25 | 0.08 | 0.69 | remainder |
| No. 90 | Ex. | 17.90 | 11.73 | 0.96 | 0.045 | 0.09 | 0.09 | 2.57 | 0.06 | 0.19 | remainder |
| No. 91 | Ex. | 18.22 | 13.22 | 0.87 | 0.012 | 0.05 | 0.10 | 2.86 | 0.07 | 0.32 | remainder |
| No. 92 | Ex. | 18.23 | 10.23 | 0.45 | 0.183 | 0.11 | 0.11 | 2.45 | 0.07 | 0.48 | remainder |
| No. 93 | Comp. | 16.55 | 12.73 | 0.57 | 0.055 | 0.00 | 0.06 | 2.65 | 0.13 | 0.29 | remainder |
| | Ex. | | | | | | | | | | |
| No. 94 | Comp. | 16.42 | 12.48 | 0.76 | 0.033 | 0.09 | 0.00 | 2.15 | 0.12 | 0.33 | remainder |
| | Ex. | | | | | | | | | | |
| No. 95 | Comp. | 17.85 | 12.46 | 0.37 | 0.015 | 0.67 | 0.09 | 2.53 | 0.17 | 0.43 | remainder |
| | Ex. | | | | | | | | | | |
| No. 96 | Comp. | 17.63 | 12.75 | 0.45 | 0.022 | 0.07 | 0.63 | 2.75 | 0.15 | 0.38 | remainder |
| | Ex. | | | | | | | | | | |
| | | | | | | | | Sintered body | | | |
| | | | Metal powder for powder metallurgy | | | | | Surface | Inner | | |
| | | | | | | | Powder | layer | part | | |
| | | | | | (E1 + E2)/ | (E1 + E2)/ | production | P2/ | P2/ | Area ratio | |
| | | Sample | E1/E2 | E1 + E2 | Si | C | method | (P1 + P2) | (P1 + P2) | difference | Remarks |
| | | No. | — | mass % | — | — | — | % | % | % | — |
| | | No. 87 | 0.50 | 0.21 | 0.27 | 8.75 | Pre-mix | 0.09 | 3.09 | 3.00 | |
| | | No. 88 | 0.50 | 0.15 | 0.21 | 8.82 | Pre-mix | 0.14 | 3.28 | 3.14 | |
| | | No. 89 | 1.25 | 0.27 | 0.30 | 11.74 | Pre-mix | 0.20 | 4.41 | 4.21 | |
| | | No. 90 | 1.00 | 0.18 | 0.19 | 4.00 | Pre-mix | 0.27 | 4.54 | 4.27 | |
| | | No. 91 | 0.50 | 0.15 | 0.17 | 12.50 | Pre-mix | 0.26 | 4.58 | 4.32 | |
| | | No. 92 | 1.00 | 0.22 | 0.49 | 1.20 | Pre-mix | 0.29 | 4.68 | 4.39 | |
| | | No. 93 | 0.00 | 0.06 | 0.11 | 1.09 | Pre-mix | 4.90 | 6.25 | 1.35 | |
| | | No. 94 | — | 0.09 | 0.12 | 2.73 | Pre-mix | 1.60 | 4.58 | 2.98 | |
| | | No. 95 | 7.44 | 0.76 | 2.05 | 50.67 | Pre-mix | 0.70 | 4.12 | 3.42 | |
| | | No. 96 | 0.11 | 0.70 | 1.56 | 31.82 | Pre-mix | 2.00 | 4.99 | 2.99 | |

In Table 15, among the sintered bodies of the respective sample Nos., those corresponding to the invention are denoted by “Ex.” (Example), and those not corresponding to the invention are denoted by “Comp. Ex.” (Comparative Example).

Each sintered body contained very small amounts of impurities, but the description thereof is omitted in Table 15.

### 12. Evaluation of Sintered Body (V—Nb Based)

### 12.1 Evaluation of Relative Density

With respect to the sintered bodies of the respective sample Nos. shown in Table 15, the sintered density was measured in accordance with the method for measuring the density of sintered metal materials specified in JIS Z 2501 (2000), and also the relative density of each sintered body was calculated with reference to the true density of the metal powder for powder metallurgy used for producing each sintered body.

The calculation results are shown in Table 16.

### 12.2 Evaluation of Vickers Hardness

With respect to the sintered bodies of the respective sample Nos . shown in Table 15, the Vickers hardness was measured in accordance with the Vickers hardness test method specified in JIS Z 2244 (2009).

The measurement results are shown in Table 16.

### 12.3 Evaluation of Tensile Strength, 0.2% Proof Stress, and Elongation

With respect to the sintered bodies of the respective sample Nos. shown in Table 15, the tensile strength, 0.2%proof stress, and elongation were measured in accordance with the metal material tensile test method specified in JIS Z 2241 (2011).

Then, these measured physical property values were evaluated according to the evaluation criteria applied to Tables 3 and 4 described above.

The above evaluation results are shown in Table 16.

### 12.4 Evaluation of Aesthetic Appearance

With respect to the sintered bodies of the respective sample Nos. shown in Table 15, polishing was performed and also the specular glossiness was measured and evaluated in the same manner as in the above-mentioned 2.5.

The above evaluation results are shown in Table 16.

### 12.5 Observation of Cross Section of Sintered Body Using Scanning Electron Microscope (SEM)

An observation image was obtained for the cross section of each sintered body using a scanning electron microscope in the same manner as in the case of the sintered body of sample No. 1. Then, P2/(P1+P2) was calculated. The calculation results are shown in Table 15.

TABLE 16

| | | Metal | | | | | | |
|---|---|---|---|---|---|---|---|---|
| | | powder | Evaluation results of sintered body | | | | | |
| | | Average | | | | 0.2% | | |
| | | particle | Relative | Vickers | Tensile | proof | | Aesthetic |
| Sample | | diameter | density | hardness | strength | stress | Elongation | appearance |
| No. | — | μm | % | — | — | — | — | — |
| No. 87 | Ex. | 4.11 | 99.0 | 174 | A | A | B | A |
| No. 88 | Ex. | 4.23 | 99.1 | 168 | A | A | A | A |
| No. 89 | Ex. | 6.87 | 98.6 | 176 | A | A | B | A |
| No. 90 | Ex. | 5.76 | 98.4 | 182 | B | B | B | B |
| No. 91 | Ex. | 3.27 | 98.8 | 160 | B | B | A | B |
| No. 92 | Ex. | 4.13 | 97.5 | 195 | B | B | C | B |
| No. 93 | Comp. Ex. | 4.01 | 96.3 | 203 | D | D | C | D |
| No. 94 | Comp. Ex. | 3.76 | 96.1 | 213 | D | D | C | D |
| No. 95 | Comp. Ex. | 4.55 | 94.6 | 216 | D | D | D | D |
| No. 96 | Comp. Ex. | 3.47 | 94.5 | 225 | D | D | E | D |

As apparent from Table 16, it was confirmed that the sintered bodies corresponding to Example each have a higher relative density than the sintered bodies corresponding to Comparative Example. It was also confirmed that there is a significant difference in properties such as tensile strength, 0.2% proof stress, and elongation between the sintered bodies corresponding to Example and the sintered bodies corresponding to Comparative Example. It was also confirmed that the sintered bodies corresponding to Example each have high specularity and therefore have excellent aesthetic appearance.

What is claimed is:

1. An ornament, comprising a sintered body, wherein in the sintered body,
Fe is contained as a major component,
Cr is contained in a proportion of 15 mass % or more and 26 mass % or less,
Ni is contained in a proportion of 7 mass % or more and 22 mass % or less,
Si is contained in a proportion of 0.3 mass % or more and 1.2 mass % or less,
C is contained in a proportion of 0.005 mass % or more and 0.3 mass % or less, and
when one element selected from the group consisting of Ti, V, Y, Zr, Nb, Hf, and Ta is defined as a first element, and one element selected from the group consisting of Ti, V, Y, Zr, Nb, Hf, and Ta, and having a higher group number in the periodic table than that of the first element or having the same group number in the periodic table as that of the first element and a higher period number in the periodic table than that of the first element is defined as a second element,
the first element is contained in a proportion of 0.01 mass % or more and 0.5 mass % or less, and
the second element is contained in a proportion of 0.01 mass % or more and 0.5 mass % or less, and
in a cross section of a surface layer with a thickness of 200 μm from the surface, when the area ratio of a first region D1 in which Fe is contained as a major component is represented by P1 and the area ratio of a second region D2 in which Si or O is contained as a major component is represented by P2, P2/(P1+P2) is 0.3% or less.

2. The ornament according to claim 1, wherein the relative density of the sintered body is 98% or more.

3. The ornament according to claim 1, wherein the sintered body has an austenite crystal structure.

4. The ornament according to claim 1, wherein the ornament is an external component for timepieces.
